(19) United States
(12) Patent Application Publication
(10) Pub. No.: US 2026/0341281 A1
(43) Pub. Date: Oct. 29, 2026

(54) VOICE DISAMBIGUATION TECHNIQUES IN MEDIA PLAYBACK SYSTEMS

(71) Applicant: Sonos, Inc., Goleta, CA (US)

(72) Inventors: Sébastien Maury, Paris (FR); David Leroy, Paris (FR); Raffaele Tavarone, Paris (FR); Julien Balian, Paris (FR); Francesco Caltagirone, Paris (FR)

(21) Appl. No.: 19/116,085

(22) PCT Filed: Sep. 29, 2023
(86) PCT No.: PCT/US2023/075489

§ 371 Date: Mar. 27, 2025

Related U.S. Application Data
(60) Provisional application No. 63/377,881, filed on Sep. 30, 2022.
(60) Provisional application No. 63/377,939, filed on Sep. 30, 2022.

(51) Int. Cl. G10L 15/30; G10L 15/08; G10L 15/18; G10L 15/22

(52) U.S. Cl. CPC G10L 15/30; G10L 15/1815; G10L 15/22; G10L 2015/088; G10L 2015/223

(57) ABSTRACT

Techniques for disambiguating voice commands through determination of acoustic spaces and/or tracking voice signatures. One example of a method of directing voice commands includes detecting, at a first playback device, a voice command executable by a plurality of playback devices, determining that an acoustic space around the first playback device includes a second playback device, and causing the second playback device to execute the voice command based on a presence of the second playback device in the acoustic space. Another example of a method of directing voice commands includes detecting a first voice command executable by a plurality of playback devices, determining that the voice command matches a stored voice signature, accessing association information that associates the stored voice signature with a second voice command and identifies a first playback device that executed the second voice command, and causing the first playback device to execute the first voice command.

### CROSS-REFERENCE TO RELATED APPLICATIONS

This application claims priority under 35 U.S.C. § 119(e), PCT Article 8, and Article 4 of the Paris Convention to co-pending U.S. Provisional Patent Application No. 63/377,881 filed Sep. 30, 2022 and titled “VOICE DISAMBIGUATION VIA ACOUSTIC SPACE DETERMINATION,” and to co-pending U.S. Provisional Patent Application No, 63/377,939 filed Sep. 30, 2022 and titled “VOICE DISAMBIGUATION TECHNIQUES IN MEDIA PLAYBACK SYSTEMS,” each of which is incorporated herein by reference in its entirety for all purposes.

### TECHNICAL FIELD

The present technology relates to consumer goods and, more particularly, to methods, systems, products, aspects, services, and other elements directed to media playback systems or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, titled “Method for Synchronizing Audio Playback between Multiple Networked Devices,” and began offering its first media playback system for sale in 2005. The SONOS Wireless Home Sound System enables people to experience music from many sources via one or more networked playback devices. Through a software control application installed on a controller (e.g., a smartphone, tablet, computing device, or voice input device) one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

FIG. 1A is a partial cutaway view of an environment having a media playback system configured in accordance with aspects of the disclosed technology;

FIG. 1B is a schematic diagram of the media playback system of FIG. 1A and one or more networks;

FIG. 2A is a functional block diagram of an example of a playback device;

FIG. 2B is an isometric diagram of an example of a housing of the playback device of FIG. 2A;

FIGS. 3A-3E are diagrams showing examples of playback device configurations in accordance with aspects of the disclosure;

FIG. 4A is a functional block diagram of an example of a controller device in accordance with aspects of the disclosure;

FIG. 5 is a functional block diagram of circuitry of an example of a network microphone device in accordance with aspects of the disclosure;

FIG. 6 is a conceptual diagram illustrating aspects of a positioning system architecture in accordance with aspects of the disclosure;

FIGS. 7A-7E are diagrams illustrating examples of a media playback system environment demonstrating examples of voice disambiguation techniques in accordance with aspects of the disclosure;

FIGS. 8A-C are diagrams illustrating another example of a media playback system environment in which voice disambiguation techniques may be implemented in accordance with aspects of the disclosure;

FIG. 9 is a sequence diagram illustrating one example of a voice disambiguation method in accordance with aspects of the disclosure;

FIG. 10 is a diagram illustrating another example of a media playback system environment in which voice disambiguation techniques may be implemented in accordance with aspects of the disclosure;

FIG. 11 is a flow diagram illustrating one example of a method of disambiguating voice commands using acoustic space in accordance with aspects of the disclosure;

FIGS. 12A-E are diagrams illustrating further examples of the media playback system environment of FIGS. 8A-C in which voice disambiguation techniques may be implemented in accordance with aspects of the disclosure;

FIG. 13 is a flow diagram illustrating one example of a voice disambiguation method in accordance with aspects of the disclosure;

FIGS. 14A-C are diagrams illustrating another example of a media playback system environment having multiple acoustic spaces in accordance with aspects of the disclosure;

FIG. 15 is a flow diagram illustrating one example of a method of using acoustic space determination in combination with voice signature matching for voice disambiguation in accordance with aspects of the disclosure; and

FIG. 16 is a flow diagram illustrating one example of a method of tracking voice signatures in accordance with aspects of the disclosure.

### DETAILED DESCRIPTION

### I. OVERVIEW

Aspects and embodiments are directed to techniques for allowing voice-based control of various aspects of a media playback system, such as beginning, pausing, and/or stopping playback of audio, selecting an audio content source, selecting a type of audio or specific audio content (e.g., a particular song) to be played, or changing the volume of playback, to name a few. Unlike control commands that are implemented through an electronic controller device (which inherently associates very precise information with each available action or command), in many instances, voice commands issued by a user may be ambiguous in nature. For example, voice commands that do not identify a target playback device or group of playback devices can be ambiguous in that the media playback system may not be able to determine which playback device or group of playback devices is to execute the voice command. Consider, for example, a media playback system that includes a playback device playing music in the kitchen of a user's home and another playback device playing music in a bedroom of the user's home. If the user utters a command such as, “hey Sonos, stop the music,” for example, the user's intent may be ambiguous-did the user intend to stop the music in the kitchen, the bedroom, or both? Similarly, a voice command such as “play my music in the Living Room” may be ambiguous as to exactly what music the user wishes to be played (e.g., which audio source, what audio content, etc.), even though the command identifies the target playback zone. This problem becomes more significant when there are multiple users using the media playback system simultaneously in that an ambiguous voice command from one user can interfere with the listening experience of another user.

Rather than requiring the user to always provide precise, unambiguous voice commands, aspects and embodiments are directed to techniques by which the media playback system may autonomously resolve such ambiguity in voice commands and automatically take corresponding actions without having to request clarification from the user. These attributes and capabilities may allow the user to interact with the media playback system in a more natural, streamlined way, thereby providing an enhanced user experience.

According to certain aspects and embodiments, one or more playback devices in a media playback system can be configured to resolve potential ambiguity in an uttered voice command (referred to herein as “disambiguating” the voice command). In some examples, this is achieved by determining the “acoustic space” in which the voice command was received and directing the voice command to a playback device or group of playback devices that are located in the same acoustic space. As used herein, the term “acoustic space” is a spatial region that is represented by a list of network devices in the media playback system that are detected by a listening device (a network device that detects the voice command uttered by the user), for example, in response to a localization request issued by the listening device after it detects the voice command from the user. This list of network devices may correspond approximately to a list of network devices that are within audible range of the user and may be determined based on the position of the network device that detects the voice command and positions of other network devices in the media playback system. Considering the example discussed above in which first content is being played in a bedroom and second content is being played in the kitchen, according to certain examples, when a user speaks a command (e.g., to stop the music), the media playback system may determine the acoustic space in which the user spoke the command. Based on this determination, the media playback system may infer which of the playback devices is to execute the voice command.

As discussed in more detail below, the acoustic space around a particular network device may be determined in various ways and using any of a variety of wireless communications or sensing technologies, including using acoustic signal detection and/or signal strength measurements, for example. In addition, as the user moves within an environment in which the media playback system is deployed, the listening device(s) that detect voice commands may vary with the user's changing position, as may the list the network devices that can be detected by a given listening device at any given time. Accordingly, the acoustic space may dynamically change and be “redetermined” whenever a listening device may need to use the acoustic space to disambiguate a voice command in accord with aspects and examples disclosed herein.

In some examples, disambiguating the voice command is achieved by tracking different users' voice interactions throughout the environment in which the media playback system is deployed to infer one or more target playback devices for an ambiguous voice command. In particular, certain embodiments involve tracking a user's voice signature identified at the time of speaking the voice command, as discussed in more detail below.

According to certain examples, by creating a unique voice identifier, referred to herein as a voice signature, associated with the voice of a specific user (which may be stored as a system state variable, for example) and tracking, via the voice signature, interactions between the user and the media playback system, the media playback system may infer how the user intends the system to operate. For example, consider the following scenario. A user starts playback of certain music on a playback device in the Bedroom, moves to the Kitchen and gives a voice command captured by a network device in the Kitchen speaker to stop the music. At this time, the playback device in the Bedroom is playing back music as initiated by the user, but one or more additional playback devices could also be playing music initiated by another user. For example, another playback device on the Patio may be playing back music initiated by the other user. In certain examples, the media playback system can infer that the music should be stopped in the Bedroom, which is where the user giving the current voice command started playback, rather than on the Patio, where the music was started by another user. The media playback system can make such an inference by having knowledge of the previous actions of the different users. For example, user A started playback of content Ca at room Ra, and user B started playback of content Cb at room Rb, and so on. Thus, based on tracked and correlated voice signatures and information, the media playback system can autonomously resolve otherwise ambiguous voice commands.

Under this approach, the media playback system does not necessarily need to have knowledge of who is the user giving the voice command. The system can merely identify that a person speaking has spoken before and be able to infer the voice command target from the past interactions. There is no need to specifically identify certain users or acquire and store specific user identity information, as is done by certain other voice activated service (VAS) providers. Thus, the privacy of the users is maintained, while still enabling the media playback system to autonomously take user-specific actions and operate in ways that can differentiate between multiple users. Furthermore, voice signature identification can be performed autonomously and dynamically by the media playback system without requiring users to “register” or undergo any identification process.

According to certain examples, the voice signature can be a temporary identifier that only exists in the media playback system for a limited period of time. For example, after a certain time without receiving any voice commands from user A, the voice signature data associated with user A can be removed from the system such that it does not persist indefinitely. In certain examples, the time period can be relatively short, such as in a range of about 30 minutes to a few hours, for example. This provides privacy benefits as well as certain advantageous system characteristics. For example, in one aspect, using such temporarily-stored voice signature IDs enables access to the system in which a user, such as a guest, can interact without storing any data permanently on the system (unlike typical voice signature implementations). The data can also be reset after a certain period of inactivity so that the next time that the user attempts to use the media playback system, the system is not limited by any old configuration. In some implementations, temporary voice signatures can be detected by processing background speech, for example, to detect voice signatures regardless of whether a user spoke a voice command. When a voice command is later detected by a network device in the media playback system within a predetermined time period after detecting the voice signature, the voice signature can be used to resolve ambiguities until that voice signature no longer persists in the system.

Thus, aspects and embodiments provide disambiguation techniques that can be used to assist the media playback system to autonomously disambiguate voice commands using acoustic space determination and/or temporary voice signatures that can be associated with system state information. As discussed further below, using the disambiguation techniques disclosed herein, the media playback system can identify one or more playback device(s) to execute an otherwise ambiguous voice command without requiring that the user provide clarifying information, such as information identifying groups of playback devices, playback zones, etc. Examples of the disambiguation approaches disclosed herein may be useful for allowing a user to easily control portable playback devices which may move in and out of different acoustic spaces.

In addition, according to certain examples, the media playback system may use historical system state information, optionally in combination with determining the relevant acoustic space, to disambiguate certain voice commands. For example, the media playback system may be configured to identify a playback device currently executing a prior, related voice command uttered by the user, and to disambiguate a current voice command based on this historical information. These and other examples are discussed in more detail below.

According to certain embodiments, a method of directing voice commands for playback devices comprises detecting a voice input via a first playback device, the voice input including a voice command to be executed by at least one playback device in a set of playback devices, determining that the voice input does not identify any playback device in the set of playback devices, and after the determination, causing the set of playback devices to broadcast a set of signals, wherein each playback device in the set of playback devices broadcasts a respective signal in the set of signals. The method further comprises detecting, via the first playback device, one or more respective signals in the set of signals, identifying at least one second playback device of the set of playback devices based on the detected one or more respective signals, and causing the at least one second playback device to execute the voice command.

According to certain embodiments, a method of directing voice commands in a media playback system comprises detecting a first voice input including a first voice command to be executed by a first playback device in the media playback system, deriving a first voice signature from the first voice input, temporarily storing a first data set comprising the first voice signature and association information that associates the first voice signature with the first voice command and the first playback device, detecting a second voice input including a second voice command executable by a plurality of playback devices in the media playback system, the plurality of playback devices including the first playback device, deriving a second voice signature from the second voice input, comparing the first voice signature to the second voice signature, identifying a signature match based on the comparison, and based on the signature match and the association information stored in the first data set, causing the first playback device to execute the second voice command.

While some examples described herein may refer to functions performed by given actors, such as “users,” “listeners,” and/or other entities, it should be understood that these references are for purposes of explanation only. The claims should not be interpreted to require action by any such example actor unless explicitly required by the language of the claims themselves.

### II. EXAMPLE OPERATING ENVIRONMENT

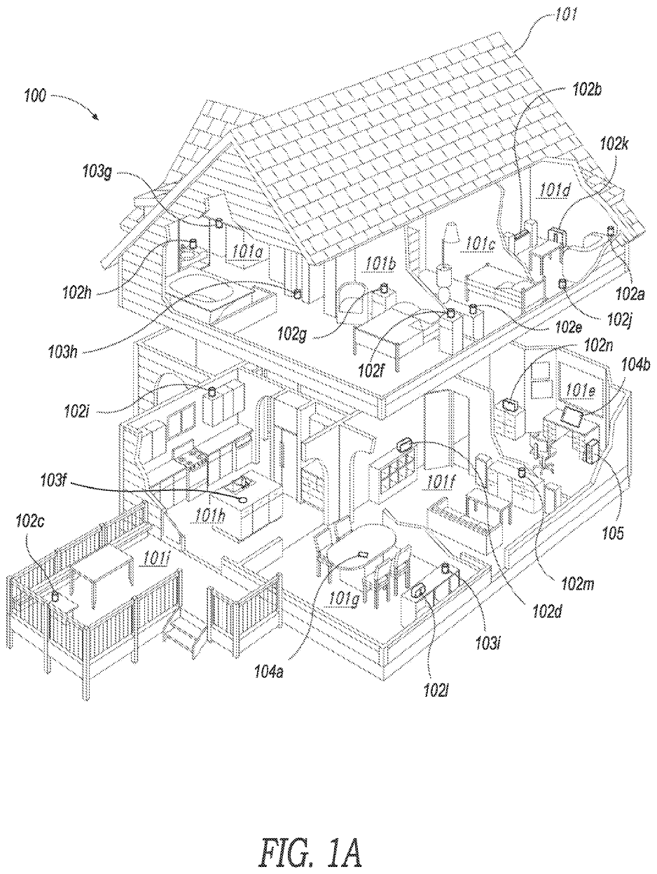

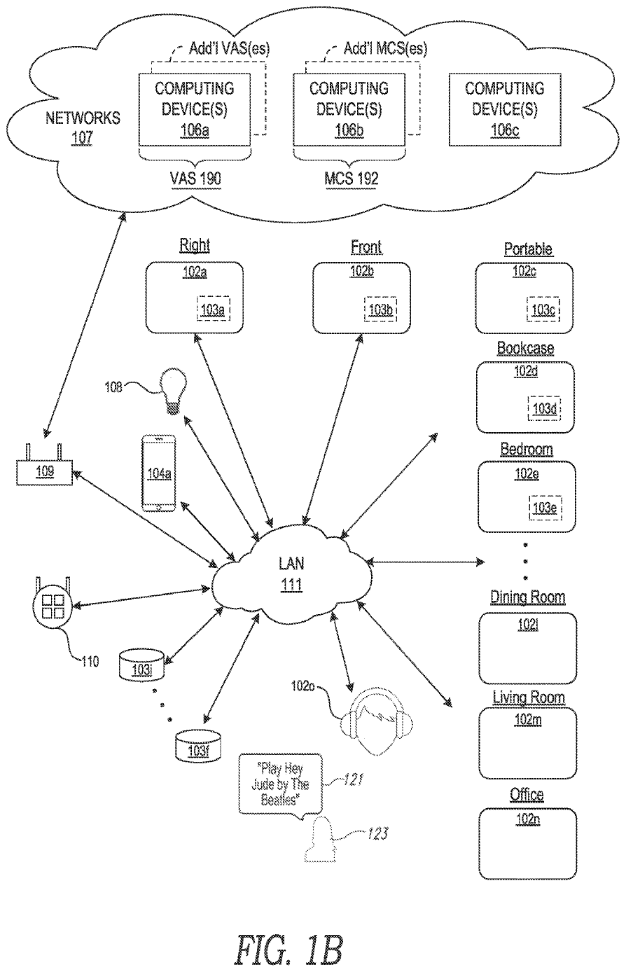

FIGS. 1A and 1B illustrate an example configuration of a media playback system 100 (or “MPS 100”) in which one or more examples disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a Master Bathroom 101a, a Master Bedroom 101b (referred to herein as “Nick's Room”), a Second Bedroom 101c, a Family Room or Den 101d, an Office 101e, a Living Room 101f, a Dining Room 101g, a Kitchen 101h, and an outdoor Patio 101i. While certain aspects and examples are described below in the context of a home environment, the technologies described herein may be implemented in other types of environments. In some examples, for instance, the MPS 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-103i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A).

As used herein the term “playback device” can generally refer to a network device configured to receive, process, and output data of a media playback system, such as the MPS 100. For example, a playback device 102 can be a network device that receives and processes audio content. In some embodiments, a playback device 102 includes one or more transducers or speakers powered by one or more amplifiers, as discussed further below. In other embodiments, however, a playback device 102 includes one of (or neither of) the speaker and the amplifier. For instance, a playback device 102 can comprise one or more amplifiers configured to drive one or more speakers external to the playback device 102 via a corresponding wire or cable.

As used herein the term NMD (i.e., a “network microphone device”) can generally refer to a networked computing device that is configured for audio detection. As such, the NMD 103 may include a microphone that is configured to detect sounds in the NMD's environment.

In various implementations, one or more of the playback devices 102 may take the form of or include an on-board (e.g., integrated) network microphone device. A playback device 102 that includes components and functionality of an NMD 103 may be referred to as being “NMD-equipped.” For example, the playback devices 102a-e include or are otherwise equipped with corresponding NMDs 103a-e, respectively. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output.

The term “control device” can generally refer to a network device configured to perform functions relevant to facilitating user access, control, and/or configuration of the media playback system 100.

In examples described below, one or more of the various playback devices 102 may be configured as portable playback devices, while others may be configured as stationary playback devices. For example, certain playback devices 102, such as the headphones 1020 (FIG. 1B) or the playback device 102c on the Patio 101i, for example, may include an internal power source (e.g., a rechargeable battery) that allows the playback device to operate without being physically connected to a mains electrical outlet or the like. In this regard, such a playback device may be referred to herein as a “portable playback device.” On the other hand, playback devices that are configured to rely on power from a mains electrical outlet or the like (such as the playback device 102d, for example) may be referred to herein as “stationary playback devices,” although such devices may in fact be moved around a home or other environment. In practice, a person might often take a portable playback device to and from a home or other environment in which one or more stationary playback devices remain.

The various playback and network microphone devices 102 and 103 of the MPS 100 may each be associated with a unique name, which may be assigned to the respective devices by a user, such as during setup of one or more of these devices. For example, some playback devices may be assigned names according to a zone or room in which the playback devices are located. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). Other naming conventions are possible.

With reference still to FIG. 1B, the various playback, network microphone, and controller devices 102-104 and/or other network devices of the MPS 100 may be coupled to one another via point-to-point connections and/or over other connections, which may be wired and/or wireless, via a LAN 111 including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related example, the Left playback device 102j may communicate with other network devices, such as the playback device 102b, which may be designated as the “Front” device, via a point-to-point connection and/or other connections via the LAN 111.

As further shown in FIG. 1B, the MPS 100 may be coupled to one or more remote computing devices 106 via a wide area network (“WAN”) 107. In some examples, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101.

In some implementations, the various playback devices, NMDs, and/or controller devices 102-104 may be communicatively coupled to at least one remote computing device associated with a voice activated service (“VAS”) and at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS, or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless Home Sound Systems.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the LAN 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some examples, the remote computing device(s) and the media playback system 100 may exchange data via communication paths as described herein and/or using a metadata exchange channel as described in U.S. Pat. No. 10,499,146 issued Dec. 3, 2019, and titled “Voice Control of a Media Playback System,” which is herein incorporated by reference in its entirety.

Upon receiving the stream of sound data, the VAS 190 determines if there is voice input specifying a voice command in the streamed data from the NMD, and if so the VAS 190 will also determine an underlying intent in the voice command. The VAS 190 may next transmit a response back to the MPS 100, which can include transmitting the response directly to the NMD that caused the wake-word event. The response is typically based on the intent that the VAS 190 determined was present in the voice command. As an example, in response to the VAS 190 receiving a voice command with an utterance to “Play Hey Jude by The Beatles,” the VAS 190 may determine that the underlying intent of the voice command is to initiate playback and further determine that intent of the voice command is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in U.S. Pat. No. 10,499,146 referenced above.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 1021, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in U.S. Pat. No. 10,499,146 referenced above.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the LAN 111 (FIG. 1B) may be eliminated and the single playback device 102 and/or the single NMD 103 may communicate directly with the remote computing devices 106a-d. In some examples, a telecommunication network (e.g., an LTE network, a 5G network, etc.) may communicate with the various playback, network microphone, and/or controller devices 102-104 independent of a LAN.

### a. Example Playback & Network Microphone Devices

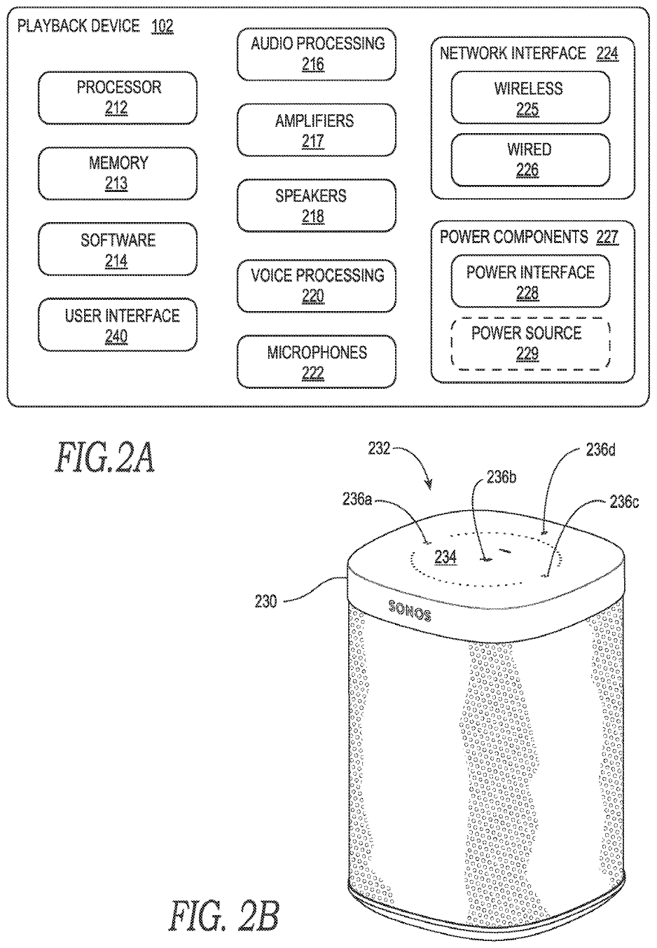

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies, such as audible frequencies below about 500 Hz), a mid-range driver (e.g., for middle frequencies, such as audible frequencies between about 500 Hz and about 2 kHz), and/or a tweeter (e.g., for high frequencies, such as audible frequencies above 2 kHz). In some cases, a transducer may be driven by an individual corresponding audio amplifier of the audio amplifiers 217. In some implementations, a playback device may not include the speakers 218, but instead may include a speaker interface for connecting the playback device to external speakers. In certain examples, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.11ax, 802.15, 4G or 5G mobile communication standard, WI-FI 4, 5, or 6 standards, and so on). The wireless interface(s) 225 may also enable the playback device 102 to communicate using technologies and protocols such as BLUETOOTH, ultrasound, acoustic signaling, and ultra-wideband radio, to name a few. A wired interface may provide network interface functions for the playback device 102 to communicate over a wired connection with other devices in accordance with a communication protocol (e.g., IEEE 802.3). While the network interface 224 shown in FIG. 2A includes both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphone).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

In some implementations, the voice-processing components 220 may detect and store a user's voice profile, which may be associated with a user account of the MPS 100. For example, voice profiles may be stored as and/or compared to variables stored in a set of command information or data table. The voice profile may include aspects of the tone or frequency of a user's voice and/or other unique aspects of the user's voice, such as those described in U.S. Pat. No. 10,499,146 referenced above.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independently of an external power source. In some such implementations, the external power source interface 228 may be configured to facilitate charging the internal power source 229. As discussed above, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various examples, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive sound from the environment of the playback device 102. The microphones 222 may be arranged in various positions along and/or within the top portion 234 or other areas of the housing 230 so as to detect sound from one or more directions relative to the playback device 102.

By way of illustration, Sonos, Inc. presently offers (or has offered) for sale certain playback devices that may implement certain of the examples disclosed herein, including a “PLAY: 1,” “PLAY: 3,” “PLAY: 5,” “PLAYBAR,” “CONNECT: AMP,” “PLAYBASE,” “BEAM,” “CONNECT,” “AMP,” “PORT,” and “SUB.” Any other past, present, and/or future playback devices may additionally or alternatively be used to implement the playback devices of example aspects disclosed herein. Additionally, it should be understood that a playback device is not limited to the examples illustrated in FIG. 2A or 2B or to the Sonos product offerings. For example, a playback device may include, or otherwise take the form of, a wired or wireless headphone set, which may operate as a part of the media playback system 100 via a network interface or the like. In another example, a playback device may include or interact with a docking station for personal mobile media playback devices. In yet another example, a playback device may be integral to another device or component such as a television, an LP turntable, a lighting fixture, or some other device for indoor or outdoor use.

### b. Example Playback Device Configurations

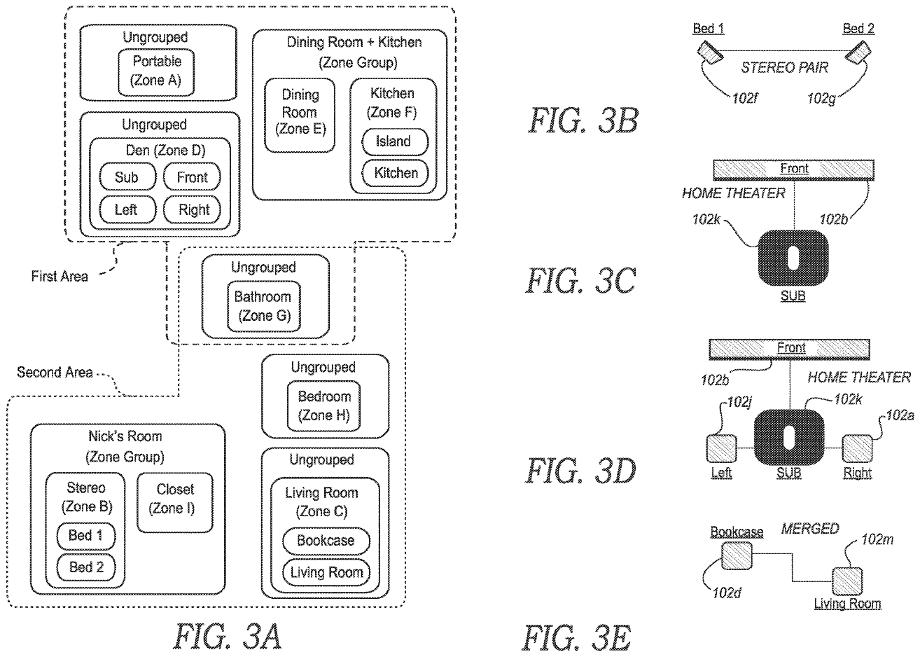

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various examples, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some examples, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the Master Bedroom 101b (FIG. 1A) and the Bed 2 device may be the playback device 102g also in the Master Bedroom 101b (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one example, the playback devices 102d and 102m may playback audio in synchrony, during which each outputs the full range of audio content that each respective playback device 102d and 102m is capable of rendering.

In some examples, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in U.S. Pat. No. 10,499,146 referenced above. In some examples, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in U.S. Pat. No. 8,234,395 referenced above. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some examples, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring again to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the media playback system 100, which may be shared from time to time among the devices so that one or more of the devices have the most recent data associated with the system.

In some examples, the memory 213 of the playback device 102 may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. Pat. No. 10,712,997 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some examples, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In examples described below, the memory 213 is configured to store a set of command data for selecting a particular VAS when processing voice inputs.

During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone. For instance, the user may be in the Office zone where the playback device 102n is playing the same hip-hop music that is being played by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in U.S. Pat. No. 8,234,395 referenced above.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. In other instances, the MPS may automatically reconfigure one or more playback devices based on tracking the movement of at least one portable playback device and acquiring localization information for the at least one portable playback devices, as discussed in more detail below. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the Living Room space, and another user to watch the television in another area of the Living Room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### c. Example Controller Devices

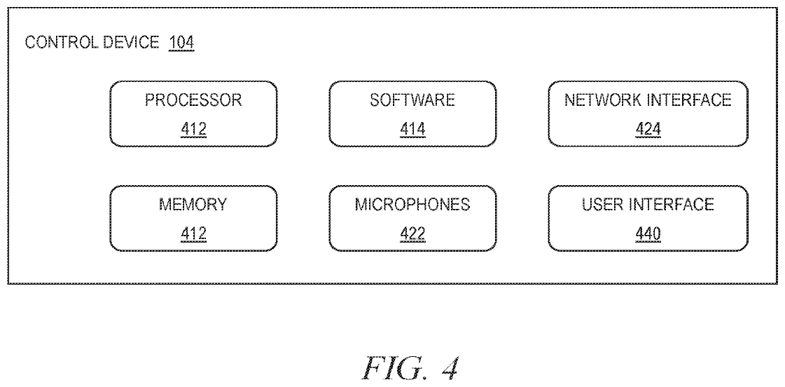

FIG. 4A is a functional block diagram illustrating certain aspects of a selected one of the controller devices 104 of the MPS 100 of FIG. 1A. Such controller devices may also be referred to herein as a “control device” or “controller.” The controller device shown in FIG. 4A may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others. Accordingly, the controller device includes a user interface 440 that is generally configured to facilitate user access and control of the MPS 100. The user interface 440 may include a touch-screen display or other physical interface configured to provide various graphical controller interfaces to allow a user to interact with the MPS 100. For example, the user interface 440 may allow the user to instruct one or more playback devices 102 to play music (including actions such as pause, skip, fast forward, stop, etc.), view, create, and/or modify playback zones or playback device groupings within the MPS 100, view information about the music being played (e.g., song title, artist, etc.), and/or create, modify, and view playlists, among various other activities. Examples of controller devices 104 are described in more detail in previously referenced U.S. Pat. No. 10,499,146, for example.

### D. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some examples, audio content may be provided by one or more media content services.

Example audio content sources may include a memory of one or more playback devices in a media playback system such as the MPS 100 of FIG. 1A, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

### e. Example Network Microphone Devices

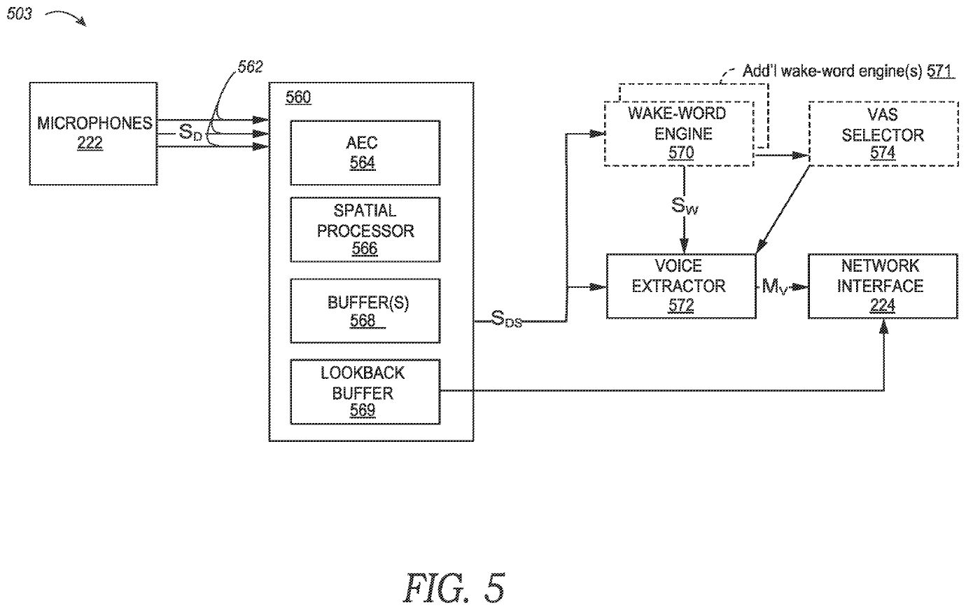

FIG. 5 is a functional block diagram showing an NMD 503 configured in accordance with aspects of the disclosure. The NMD 503 includes voice capture components (“VCC”, or collectively “voice processor 560”), and optionally also includes a wake-word engine 570, and at least one voice extractor 572, each of which is operably coupled to the voice processor 560. The NMD 503 further includes the microphones 222 and the at least one network interface 224 described above and may also include other components, such as audio amplifiers, interface, etc., which are not shown in FIG. 5 for purposes of clarity. The NMD 503 may be any of the NMDs 103 discussed above and/or may be incorporated (in whole or in part) in any NMD-equipped playback device 102, as discussed above.

The microphones 222 of the NMD 503 are configured to provide detected sound, SD, from the environment of the NMD 503 to the voice processor 560. The detected sound SD may take the form of one or more analog or digital signals. In example implementations, the detected sound SD may be composed of a plurality of signals associated with respective channels 562 that are fed to the voice processor 560.

Each channel 562 may correspond to a particular microphone 222. For example, an NMD having six microphones may have six corresponding channels. Each channel of the detected sound SD may bear certain similarities to the other channels but may differ in certain regards, which may be due to the position of the given channel's corresponding microphone relative to the microphones of other channels. For example, one or more of the channels of the detected sound SD may have a greater signal to noise ratio (“SNR”) of speech to background noise than other channels.

As further shown in FIG. 5, the voice processor 560 includes an AEC 564, a spatial processor 566, and one or more buffers 568. In operation, the AEC 564 receives the detected sound SD and filters or otherwise processes the sound to suppress echoes and/or to otherwise improve the quality of the detected sound SD. That processed sound may then be passed to the spatial processor 566.

The spatial processor 566 is typically configured to analyze the detected sound SD and identify certain characteristics, such as a sound's amplitude (e.g., decibel level), frequency spectrum, directionality, etc. In one respect, the spatial processor 566 may help filter or suppress ambient noise in the detected sound SD from potential user speech based on similarities and differences in the constituent channels 562 of the detected sound SD, as discussed above. As one possibility, the spatial processor 566 may monitor metrics that distinguish speech from other sounds. Such metrics can include, for example, energy within the speech band relative to background noise and entropy within the speech band-a measure of spectral structure-which is typically lower in speech than in most common background noise. In some implementations, the spatial processor 566 may be configured to determine a speech presence probability, examples of such functionality are disclosed in U.S. Pat. No. 10,847,178, filed May 18, 2018, titled “Linear Filtering for Noise-Suppressed Speech Detection,” and U.S. Pat. No. 10,692,518, filed Sep. 29, 2018, and titled “Linear Filtering for Noise-Suppressed Speech Detection via Multiple Network Microphone Devices,” each of which is incorporated herein by reference in its entirety.

If the NMD 503 includes a wake-word engine 570, the wake-word engine 570 can be configured to monitor and analyze received audio to determine if any wake words are present in the audio. The wake-word engine 570 may analyze the received audio using a wake word detection process. If the wake-word engine 570 detects a wake word, a network microphone device may process voice input contained in the received audio. In some examples, the wake-word engine 570 runs multiple wake word detection algorithms on the received audio simultaneously (or substantially simultaneously). As noted above, different voice services (e.g. AMAZON's ALEXA, APPLE's SIRI, MICROSOFT's CORTANA, GOOGLE'S Assistant, etc.) each use a different wake word for invoking their respective voice service. To support multiple services, the wake-word engine 570 may run the received audio through the wake word detection algorithm for each supported voice service in parallel. In such examples, the network microphone device 103 may include VAS selector components 574 configured to pass voice input to the appropriate voice assistant service.

In operation, the one or more buffers 568—one or more of which may be part of or separate from the memory 213 (FIG. 2A)—capture data corresponding to the detected sound SD. More specifically, the one or more buffers 568 capture detected-sound data that was processed by the upstream AEC 564 and spatial processor 566.

In general, the detected-sound data form a digital representation (i.e., sound-data stream), SDS, of the sound detected by the microphones 222. In practice, the sound-data stream SDs may take a variety of forms. As one possibility, the sound-data stream SDs may be composed of frames, each of which may include one or more sound samples. The frames may be streamed (i.e., read out) from the one or more buffers 568 for further processing by downstream components, such as the wake-word engine 570 and the voice extractor 572 of the NMD 503.

In some implementations, at least one buffer 568 captures detected-sound data utilizing a sliding window approach in which a given amount (i.e., a given window) of the most recently captured detected-sound data is retained in the at least one buffer 568 while older detected-sound data are overwritten when they fall outside of the window. For example, at least one buffer 568 may temporarily retain 20 frames of a sound specimen at given time, discard the oldest frame after an expiration time, and then capture a new frame, which is added to the 19 prior frames of the sound specimen.

In practice, when the sound-data stream Sos is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, signal-to-noise ratio, microphone channel identification, and/or other information of the given sound specimen, among other examples. Thus, in some examples, a frame may include a portion of sound (e.g., one or more samples of a given sound specimen) and metadata regarding the portion of sound. In other examples, a frame may only include a portion of sound (e.g., one or more samples of a given sound specimen) or metadata regarding a portion of sound.

The voice processor 560 also includes at least one lookback buffer 569, which may be part of or separate from the memory 213 (FIG. 2A). In operation, the lookback buffer 569 can store sound metadata that is processed based on the detected-sound data SD received from the microphones 222. As noted above, the microphones 222 can include a plurality of microphones arranged in an array. The sound metadata can include, for example: (1) frequency response data for individual microphones of the array, (2) an echo return loss enhancement measure (i.e., a measure of the effectiveness of the acoustic echo canceller (AEC) for each microphone), (3) a voice direction measure; (4) arbitration statistics (e.g., signal and noise estimates for the spatial processing streams associated with different microphones); and/or (5) speech spectral data (i.e., frequency response evaluated on processed audio output after acoustic echo cancellation and spatial processing have been performed). Other sound metadata may also be used to identify and/or classify noise in the detected-sound data SD. In at least some examples, the sound metadata may be transmitted separately from the sound-data stream SDs, as reflected in the arrow extending from the lookback buffer 569 to the network interface 224. For example, the sound metadata may be transmitted from the lookback buffer 569 to one or more remote computing devices separate from the VAS which receives the sound-data stream SDs. In some examples, for instance, the metadata can be transmitted to a remote service provider for analysis to construct or modify a noise classifier.

Components of the NMD 503 downstream of the voice processor 560 may process the sound-data stream SDs. For instance, the wake-word engine 570 can be configured to apply one or more identification algorithms to the sound-data stream SDs (e.g., streamed sound frames) to spot potential wake words in the detected-sound SD. When the wake-word engine 570 spots a potential wake word, the wake-word engine 570 can provide an indication of a “wake-word event” (also referred to as a “wake-word trigger”) to the voice extractor 572 in the form of signal Sw.

In response to the wake-word event (e.g., in response to a signal Sw from the wake-word engine 570 indicating the wake-word event), the voice extractor 572 is configured to receive and format (e.g., packetize) the sound-data stream SDs. For instance, the voice extractor 572 packetizes the frames of the sound-data stream Sos into messages. The voice extractor 572 transmits or streams these messages, Mv, that may contain voice input in real time or near real time to a remote VAS, such as the VAS 190 (FIG. 1B), via the network interface 224.

With continued reference to FIG. 5, in multi-VAS implementations, the NMD 503 may include a VAS selector 574 (shown in dashed lines) that is generally configured to direct the voice extractor's extraction and transmission of the sound-data stream SDs to the appropriate VAS when a given wake-word is identified by a particular wake-word engine, such as the first wake-word engine 570a, the second wake-word engine 570b, or the additional wake-word engine 571. In such implementations, the NMD 503 may include multiple, different wake-word engines and/or voice extractors, each supported by a particular VAS.

### III. POSITIONING SYSTEM EXAMPLES

As discussed above, a plurality of network devices, such as playback devices 102 and/or NMDs 103 can be distributed within an environment 101, such as a user's home, or a commercial space (e.g., a restaurant, retail store, mall, hotel, etc.). Some of the devices may be in relatively fixed locations within the environment 101, whereas others may be portable and be frequently moved from one location to another. As the capabilities of these devices expand, it is becoming increasingly desirable to locate and interact with the devices within the environment 101. According to certain aspects, a positioning system can be implemented to determine relative positioning of devices within the environment 101 and optionally to control or modify behavior of one or more devices based on the relative positions. Positioning or localization information can be acquired through various techniques, optionally using sensors in some instances, examples of which are discussed below. In certain examples, one or more devices in the MPS 100, such as one or more playback devices 102, NMDs 103, or controller devices 104 may host a localization application that may implement operations (also referred to herein as functional capabilities or functionalities) that process localization information to enhance user experiences with the MPS 100. Examples of such operations include sophisticated acoustic manipulation (e.g., functional capabilities directed to psychoacoustic effects during audio playback) and autonomous device configuration/reconfiguration (e.g., functional capabilities directed to detection and configuration of new devices or devices that have moved or otherwise been changed in some way), among others. The requirements that these operations place on localization information vary, with some operations requiring low latency, high precision localization information and other operations being able to operate using high latency, low precision localization information.

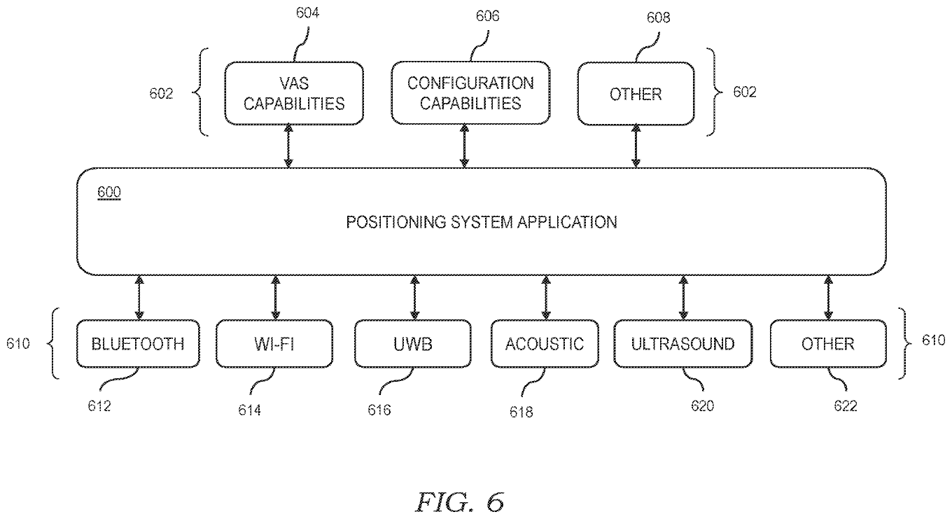

According to certain examples, a positioning system can be implemented in the MPS 100 using a variety of different devices to generate the localization information utilized by certain application functionalities. However, the number, arrangement, and configuration of these devices can vary between examples. Additionally or alternatively, the communications technology and/or sensors employed by the devices can vary. Given the number of variables in play within any particular MPS and the concomitant inefficiencies that this variability imposes on MPS application operation development and maintenance, some examples disclosed herein utilize one or more playback devices 102, NMDs 103, or controller devices 104 to implement a positioning system using a common positioning application programming interface (API) that decouples the positioning/localization information from specific devices or underlying enabling technologies, as illustrated conceptually in FIG. 6.

Referring to FIG. 6, any one or more playback devices 102, NMDs 103, or controller devices 104 in the MPS 100 (“MPS devices”) can host a positioning system application 600. In certain implementations, one or more remote computing devices can facilitate hosting the application. The positioning system application 600 implements an application programming interface (API) that exposes positioning/localization information, and metadata pertinent thereto, to MPS application functionalities 602. The MPS functionalities 602 may include a wide variety of functional capabilities relating to various user experiences and aspects of the operation of the MPS 100. For example, the MPS functionalities 602 may include one or more VAS capabilities 604, such as voice disambiguation capabilities and arbitration between different NMDs receiving the same voice inputs, for example. The MPS functionalities 602 may also include one or more MPS and/or device configuration capabilities 606, such as automatic home theatre configuration or reconfiguration, dynamically accommodating portable playback devices in home theatre environments, dynamic room assignment for portable playback devices or their associated docks, and contextual orientation of controller devices 104, to name a few. The MPS functionalities 602 may further include one or more other capabilities 608 that use positioning/localization information. To support these and other MPS functionalities 602, positioning/localization information may be used to determine various pieces of information related to the locations of MPS devices within the environment 101. For example, the positioning/localization information may be used by some MPS functionalities 602 to keep track of which playback devices 102 or NMDs 103 are in a given room or space (e.g., which playback devices are in the Living Room 101f, in which room is playback device 102d, or which playback devices 102 are closest to the controller device 104). The positioning/localization information may further be used to determine the distance and/or orientation between playback devices 102 (with varying levels of precision), or to determine the acoustic space around NMDs 103 or NMD-equipped playback devices 102 (e.g., which playback devices 102 can be heard from NMD 103a). Thus, the positioning/localization information may be used to determine information about the topology of the MPS 100 within the environment 101, which information may then be used to automatically and dynamically create or modify user experiences with the MPS 100 and support the MPS functionalities 602.

In some examples, the positioning/localization information is obtained through the exchange of wireless signals among network devices (point-to-point signaling) within the MPS 100. For example, in response to a signaling trigger, some or all of the MPS devices emit one or more wireless signals and “listen” for the wireless signals emitted by other MPS devices. Each of the wireless signal can include a device identifier that identifies the network device from which the respective wireless signal was emitted. Based on detecting the various wireless signals, one or more of the MPS devices can determine certain positioning/localization information. For example, one or more MPS devices may establish a reference pattern that describes distances and directions between MPS devices based on signal strength measurements. In another example, an MPS device may detect the presence of another MPS device based on detecting the wireless signal(s) emitted by the other MPS device. In some examples, the signaling trigger is based on a schedule. For example, some or all of the MPS devices can be configured to periodically emit and/or listen for wireless signals. In another example, a coordinating MPS device may broadcast an instruction to other MPS devices directing the other MPS devices to emit and/or listen for wireless signals. In another example, a portable playback device that detects its movement (e.g., through an on-board sensor, such as a inertial measurement unit, or through connection to or disconnection from its docking station, or via some other mechanism)may broadcast a request for other MPS devices to emit the wireless signals, such that the portable playback device can determine its new position relative to one or more of the other MPS devices by detecting the wireless signals emitted by the one or more other MPS devices. Various other examples are possible.

The positioning/localization information and metadata exposed by the positioning system application 600 may vary depending on the underlying communications technologies and/or sensor capabilities 610 within the MPS devices that are used to acquire the information and/or the needs of the particular MPS functionality 602. For example, certain MPS devices may be equipped with one or more network interfaces 224 that support any one or more of the following communications capabilities: BLUETOOTH 612, WI-FI 614 or ultra wide-band technology (UWB 616; a short-range radio frequency communications technology). Further, certain MPS devices may be equipped to support signaling via acoustic signaling 618, ultrasound 620, or other signaling and/or communications means 622. Certain technologies 610 may be well-suited to certain MPS functionalities 602 while others may more useful in other circumstances. For example, UWB 616 may provide high precision distance measurements, whereas WI-FI 614 (e.g., using received signal strength indicator (RSSI) measurements) or ultrasound 620 may provide “room-level” topology information (e.g., presence detection indicating that a particular MPS device is within a particular room or space of the environment 101). In some examples, combinations of the different technologies 610 may be used to enhance the accuracy and/or certainty of the information derived from the positioning/localization information received from one or more MPS devices via the positioning system application 600. For example, as discussed further below, in some instances, presence detection may be performed primarily using ultrasound 620; however, RSSI measurements may be used to confirm the presence detection and/or provide more precise localization information in addition to the presence detection.

Examples of MPS devices equipped with ultrasonic presence detection are disclosed in U.S. Patent Publication Nos. 2022/0066008 and 2022/0261212, each of which is hereby incorporated herein by reference in its entirety for all purposes. Examples of localizing MPS devices based on RSSI measurements are disclosed in U.S. Patent Publication No. 2021/0099736, which is herein incorporated by reference in its entirety for all purposes. Examples of performing location estimation of MPS devices using WI-FI 614 are disclosed in U.S. Patent Publication No. 2021/0297168, which is herein incorporated by reference in its entirety for all purposes.

In addition to the positioning/localization information itself, some examples of the positioning system application 600 can expose metadata that specifies localization capabilities of the host MPS device, such as precision and latency information and availability of the various underlying capabilities 610. As such, the positioning system application 600 enables the MPS functionalities 602 each to utilize a common set of API calls to identify the localization capability present within their host MPS device and to access positioning/localization information made available through the identified capabilities 610.

As shown in FIG. 6 and discussed above, the positioning system application 600 can interoperate with MPS devices that support a wide variety of localization capabilities, such as BLUETOOTH 612, WI-FI 614, UWB 616, acoustic signaling 618 and/or ultrasound 620, among others 622. In some examples, the positioning system application 600 includes one or more adapters configured to communicate with MPS devices using syntax and semantics specific to the localization capability 610 of the MPS devices. This architecture shields the MPS functionalities 602 from the complexity of interoperating with each type of MPS device. In some examples, each adapter can receive and process a stream of positioning/localization data from the MPS devices using any one or more of the capabilities 610. The adapters can interoperate with an accumulation engine within the positioning system application 600 that analyzes and merges (e.g., using a set of configurable rules) positioning/localization data obtained by the adapters and populates data structures that contain the positioning/localization information and the metadata described above. These data structures, in turn, are accessed and the positioning/localization information, and metadata, are retrieved by the positioning system application 600 in response to API calls received by the positioning system application 600 to support the MPS functionalities 602. The positioning/localization information, and metadata, can specify, in some examples, position/location of a device relative to other devices, absolute position/location (e.g., within a coordinate system) of a device, presence of device (e.g., within a structure, room, or as a simple Boolean value), and/or orientation of a device.

For instance, in some examples, the positioning/localization information is expressed in two dimensions (e.g., as coordinates in a Cartesian plane), in three dimensions (e.g., as coordinates in a Cartesian space), or as coordinates within other coordinate systems. In certain examples, the positioning/localization information is stored in one or more data structures that include one or more records of fields typed and allocated to store portions of the information. For instance, in at least one example, the records are configured to store timestamps in association with values indicative of location coordinates of a portable playback device taken at a time given by the associated timestamp. Further, in at least one example, the records are configured to store timestamps in association with values indicative of a velocity of a portable playback device taken at a time given by the associated timestamp. Further, in at least one example, the records are configured to store timestamps in association with values indicative of a segment of movement (starting and ending coordinates) of a portable playback device taken at times given by associated timestamps. Other examples of positioning/localization information, and structures configured to store the same, will be apparent in view of this disclosure.

It should be noted that the API and adapters implemented by the positioning system application 600 may adhere to a variety of architectural styles and interoperability standards. For instance, in one example, the API is a web services interface implemented using a representational state transfer (REST) architectural style. In this example, the API communications are encoded in Hypertext Transfer Protocol (HTTP) along with JavaScript Object Notation and/or extensible markup language. In some examples, portions of the HTTP communications are encrypted to increase security. Alternatively or additionally, in some examples, the API is implemented as a .NET web API that responds to HTTP posts to particular URLs (API endpoints) with localization data or metadata. Alternatively or additionally, in some examples, the API is implemented using simple file transfer protocol commands. Also, in some examples, the adapters are implemented using a proprietary application protocol accessible via a user datagram protocol socket. Thus, the adapters and the API as described herein are not limited to any particular implementation.

### IV. EXAMPLES OF TECHNIQUES FOR DISAMBIGUATING VOICE COMMANDS

As discussed above, aspects and embodiments are directed to techniques streamlining voice-based user interactions with a media playback system such as MPS 100 discussed above with reference to FIG. 1A, for example. In particular, aspects and embodiments provide apparatus and methods directed to implementing techniques by which the MPS 100 can disambiguate voice commands, such as those that do not identify particular playback devices or groups of playback devices to execute the voice commands or contain some other ambiguity.

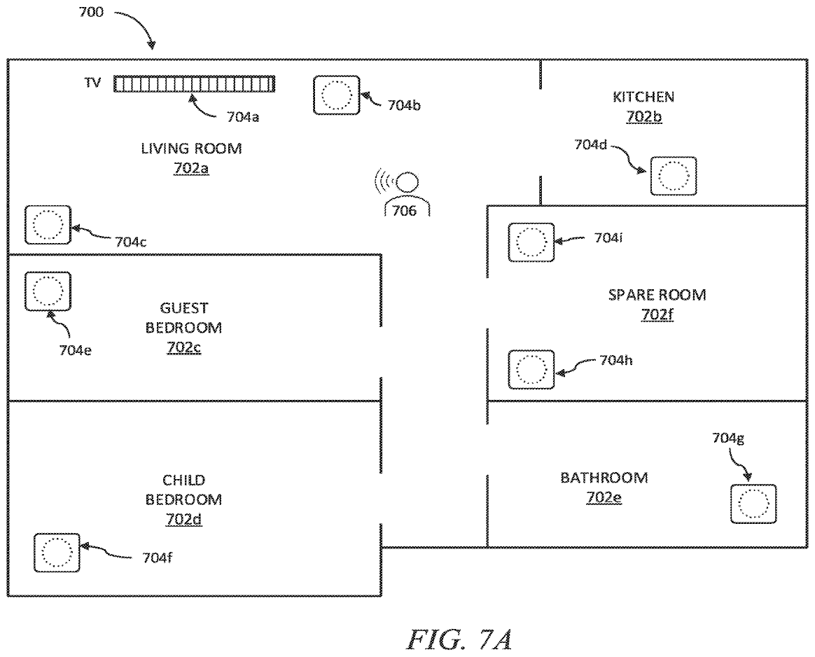

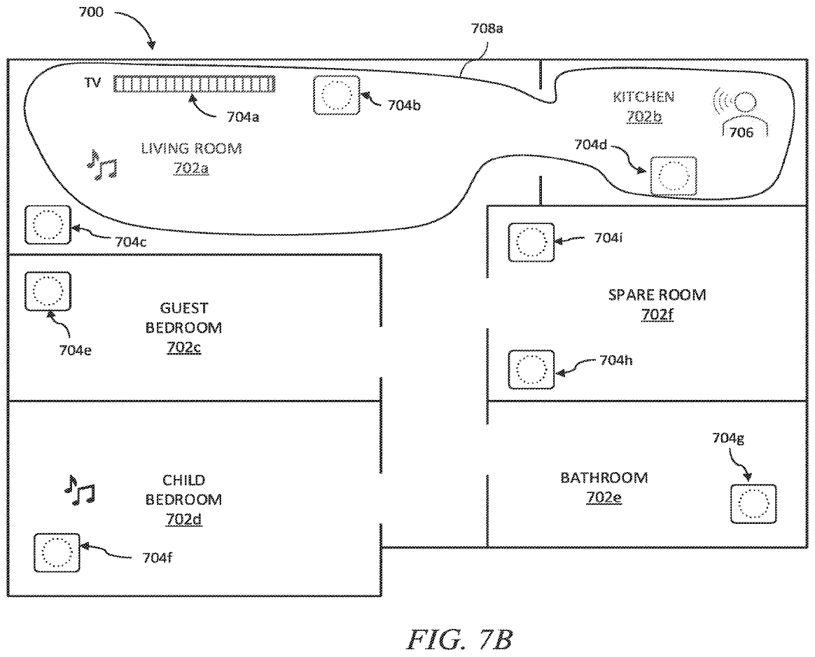

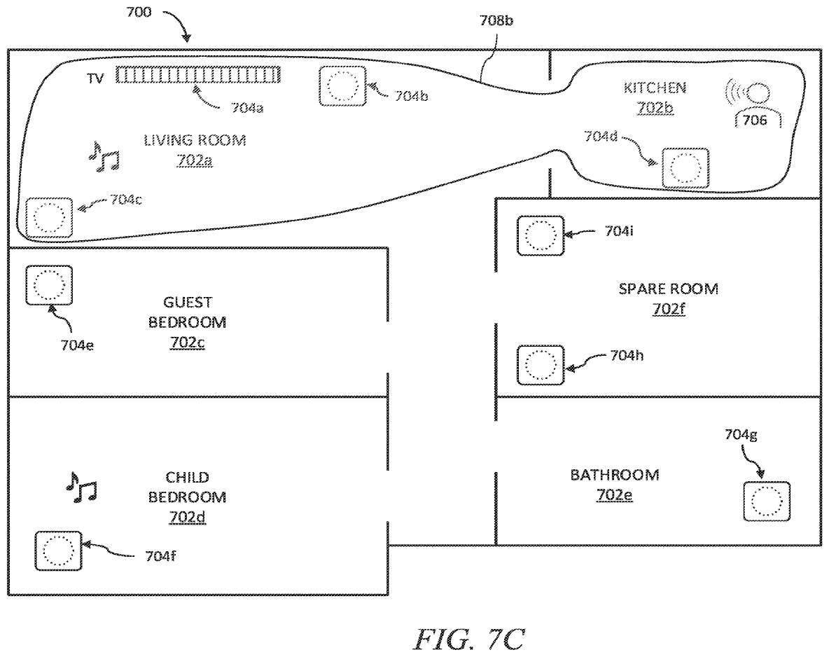

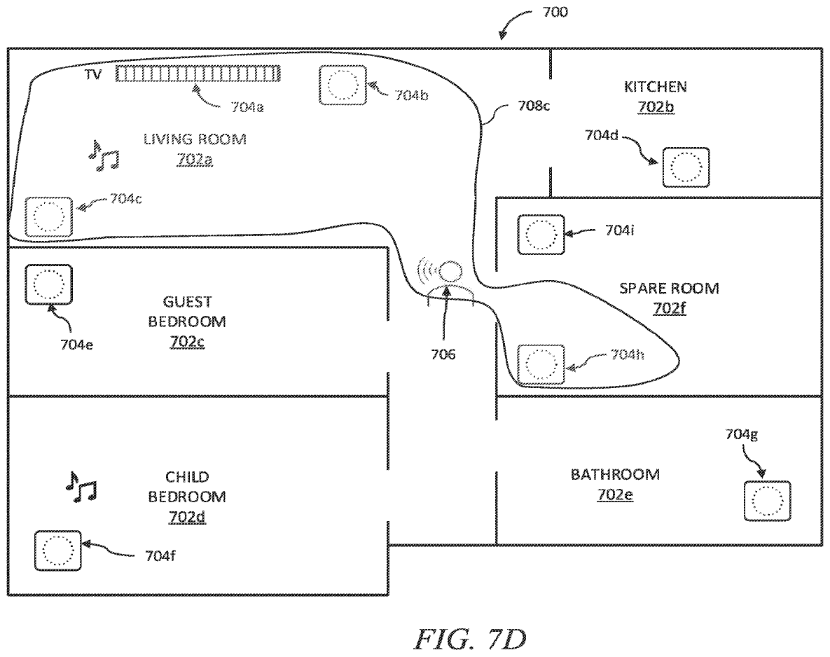

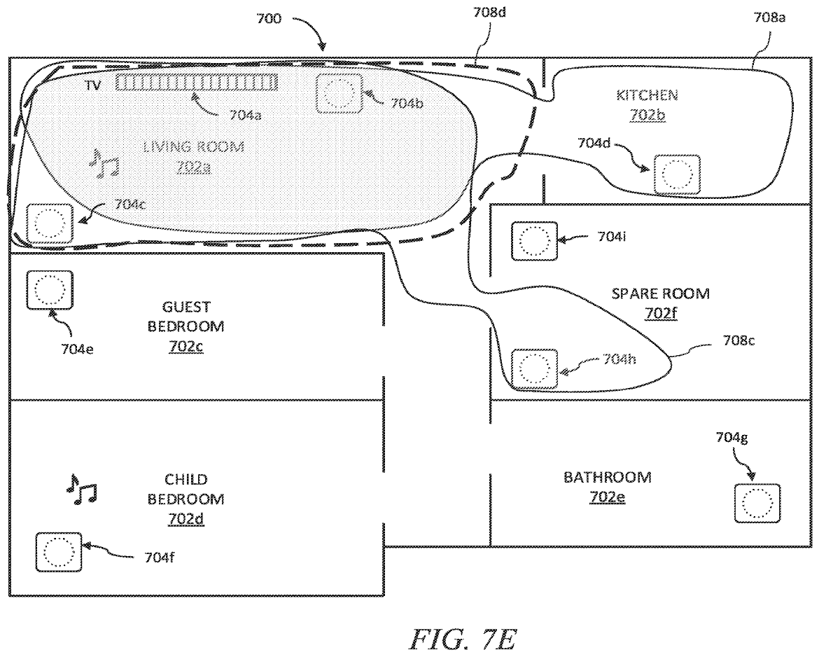

Referring to FIGS. 7A-7E, there is illustrated an example of an environment 700 in which a media playback system (e.g., such as MPS 100 discussed above) including a plurality of network devices is installed, and in which voice command disambiguation techniques according to certain examples can be implemented. In the illustrated example, the environment 700 includes several rooms and spaces identified as Living Room 702a, Kitchen 702b, Guest Bedroom 702c, Child Bedroom 702d, Bathroom 702e, and Spare Room 702f. However, it is to be appreciated that the environment 700 may include additional, fewer, or other rooms/spaces, and the example shown in FIGS. 7A-E is for purposes of illustration only. In the illustrated example, the media playback system includes a plurality of network devices 704 (identified individually as 704a-i), which may correspond to any of the playback devices 102 or NMDs 103 discussed above. At least some of the network devices 704 are NMDs or NMD-equipped playback devices capable of detecting voice input. The media playback system may include additional playback devices, NMDs, and/or controller devices not shown in FIGS. 7A-E. Further, in other examples, the media playback system may include fewer than the number network devices 704 shown in FIGS. 7A-E.

Referring to FIG. 7A, in some examples, a user 706 may provide a voice input to control some aspect of playback of audio content on one or more network devices 704. For example, the voice input can be intended to control one or more network devices 704 to begin, stop, or change (e.g., change a radio station, change the volume, etc.) playback of audio content. As used herein, “voice input” is intended to refer to speech utterances of a user that are detected by one or more network devices of the media playback system. Voice inputs may include one or more words or phrases. A “voice command” is intended to refer to a command for a network device to perform a particular action that is given in a voice input. A voice command may include one or more words or phrases. For example, the phrase “Hey, Sonos, play some Jazz” is an example of a voice input that includes a voice command (“play some Jazz) as well as a wake word (“Hey, Sonos”) specifying that the voice input is directed to the media playback system, as discussed above with reference to FIG. 1B. Voice commands may include playback commands (i.e., commands associated with aspects of audio playback, such as starting, pausing, or stopping audio playback, selecting particular audio content, changing the volume of playback, etc.) as well as other commands relating to the media playback system (referred to as system commands), such as commands to form or break a bonded group, for example, or transfer commands to transfer playback of audio to another device. As will be appreciated by those skilled in the art, given the benefit of this disclosure, playback commands and/or system commands need not be given as voice commands, but may also be given via user interface controls on a playback device (e.g., buttons, switches, etc.) or via a controller device, such as the controller devices 104 discussed above.

According to certain aspects, when a listening network device (e.g., the network device 704a) detects voice input uttered by the user 706, the listening network device may process the voice input to extract a voice command, determine an intent of the voice command (e.g., for the network device 704a to begin playback of certain audio content in this example), and cause the target network device (e.g., the network device 704a in this example) to execute the voice command, as discussed above with reference to FIGS. 1B and 2A, for example. In certain examples, the listening network device may perform this processing itself. In other examples, one or more network devices 704 in the media playback system may be designated as a “hub” device that performs some or all of the processing. In such examples, if the listening network device that detects the voice input is not the hub device, the listening network device may pass the voice input to the hub device for processing. The hub device may then cause one or more target network devices to execute the voice command based on determination(s) made during the processing. Accordingly, examples discussed herein may refer to the “media playback system” performing processing and directing various actions to be taken by one or more target devices, and it is to be understood that the processing and/or messaging to cause such actions may be performed by any one or more network devices in the media playback system, which may or may not be the same network device(s) that detect voice input from users.

In some instances, the voice input may be directly detected by the network device 704 that the user 706 intends to engage with or control. In other examples, the voice input may be detected and processed by another network device, but the voice input may specify the target network device 704 that is to be controlled. In other instances, however, the voice input may contain an ambiguous voice command.

For example, referring to FIG. 7B, in one example, the user 706 may provide a voice input that is detected by the network device 704d, the voice input containing an ambiguous voice command. For example, the user may say “stop the music” without specifying a network device 704 that is intended to execute the voice command. In the example illustrated in FIG. 7A, network devices 704a, 704b, 704c (which may be configured as a home theatre bonded group, for example), and 704f are playing audio. Without information about what the user 706 is actually hearing, and considering the fact that the network device 704d that detected the voice input may not have been the one that the user 706 intended to direct the voice input to, the media playback system may have no way to provide correct feedback (i.e., correctly execute the voice command in accord with the user's intent). For example, if the network device(s) 704a and/or 704b are NMD-equipped playback devices, the user 706 while in the Kitchen 702b is still relatively close to the network devices 704a and 704b and may have intended one of these network devices to receive the voice input, rather than the network device 704d. In that instance, given that the network devices 704a, 704b are playing audio in this example, the voice command “stop the music,” if received at either of the network devices 704a, 704b, may not be ambiguous. However, network device 704d, which is in a different room, may require additional information to correctly determine the intent of the voice command and cause the correct network device 704, or group of network devices 704, to execute the command.

Accordingly, certain aspects and embodiments are directed to inferring the acoustic space surrounding the user 706 by determining the acoustic space around the network device that detected and is processing the voice input (referred to herein as the listening device), and based on knowledge of the acoustic space, identifying a network device, or group of network devices, to execute the voice command(s) contained in the voice input.

Still referring to FIG. 7B, when the user is in the Kitchen 702b as shown, an acoustic space 708a may include the entirety of the Kitchen 702b and a portion, but not all of, the Living Room 702a. In this example, the network devices 704a and 704b share the acoustic space 708a with the listening device (network device 704d in this example), but the network device 704c is not a part of the acoustic space 708a. Reasons that the network device 704c is not a part of the acoustic space 708a can include the distance and/or orientation of the network device 704c from the listening device, an obstruction residing between the listening device and the network device 704c, or simply that a microphone of the network device 704c is not operational (powered off, etc.). Given this example, it should be noted that, the acoustic space 708a is not necessarily tied to a floorplan of rooms.

Thus, in the example illustrated in FIG. 7B, considering the layout of the environment 700, only the network devices 704a and 704b in the Living Room 702a may be heard by the user 706 located in the Kitchen 702b. As shown in FIG. 7B, the group of network devices 704a and 704b are in the same acoustic space 708 as the listening device because the sound from this group of devices can be detected by the network device 704d. The user 706 is in the same acoustic space 708 as the network device 704d because the network device 704d detected the voice input from the user 706. Thus, the media playback system (e.g., the network device 704d and/or one or more other network devices 704) may infer that the group of network devices 704a and 704b are also in the same acoustic space as the user 706. In contrast, the network device 704f in the Child Bedroom 702d is not in the acoustic space of any of the network devices 704a, 704b, and 704d. Accordingly, the media playback system may determine that the voice command included in the voice input from the user 706 (“stop the music” in this example) is intended for the group of network devices 704a, 704b, (and 704c by implication of 704c being grouped with 704a and 704b but not due to 704c being in the same acoustic space as 704a, 704b, and 704d), and not for the network device 704f. Thus, knowing the acoustic space around the user 706, which may be inferred based on the listening device and relative positional information for other network devices in the media playback system, can improve automatic ambiguity resolution.

As discussed above, in certain examples, the user 706 can be inferred to be in the same acoustic space as the listening device based on the listening device detecting the voice input uttered by the user. In other examples, one or more network devices in the media playback system, including the listening device, can be configured to determine an approximate physical location of the user relative to the one or more network devices, and at least partially determine, or confirm, the acoustic space surrounding the user based on this information. For example, the voice input detected and processed by the listening device may contain directional information corresponding to the voice input. In one example, during a setup process, for example, the listening device may have determined, correlated and stored in memory, locations of other network devices relative to the listening device, as described in U.S. Patent Publication No. 2021/0377658, which is hereby incorporated herein by reference in its entirety for all purposes. As such, the physical location of the user 706 may be approximated based on a direction from which the voice input was detected by the listening device.

In another example, one or more other devices in the media playback system (in addition to the listening device) may also include network microphone devices and/or other sensors. Accordingly, a network of available sensors may be configured to determine proximity or locate (i.e. via triangulation, etc.) the user 706 when the user provides the voice input to the corresponding network microphone device. For example, as discussed in U.S. Patent Publication No. 2021/0377658 referenced above, a location of the user, or proximity between the user and various network devices may be determined based on a signal strength between various network devices. Similarly, an audio magnitude of the voice input as detected by the other network microphone devices, or wireless signal interference caused by the user 706 between the various devices may also be used to approximate the physical location of the user when the voice input is detected.

In certain examples, based on the proximity of the network device 704d and the network device 704i, the network device 704i may also be in the same acoustic space 708 as the network device 704d. However, in the illustrated example, the network device 704i is not playing audio and therefore, the network device 704d may conclude that a voice command of “stop the music” is not intended for the network device 704i. Accordingly, in certain examples, the media playback system may use system state information, such as which network devices 704 are playing audio versus which are not, and various other information regarding the contexts of the various network devices in the media playback system, to further assist in disambiguating voice commands, as discussed in more detail below.

Referring to FIG. 7C, another example of an acoustic space 708b is illustrated. In this example, the network device 704c is included in the acoustic space 708b with the network devices 704a, 704b, and the listening device. For instance, a door to the Kitchen 702b may have been opened or further opened relative to the environment of the acoustic space 708a. This situation allows the network device 704c and the listening device to communicate better acoustically relative to the situation described above with reference to FIG. 7A.

FIG. 7D illustrates another example of an acoustic space 708c. In this example, the user 706 utters a voice input that is detected by the network device 704h. The network device 704h, as the listening device, interoperates with the network devices 704a, 704b, and 704c to establish the acoustic space 708c.

Referring to FIG. 7E, a combination acoustic space 708d is illustrated. In this example, the system can infer (e.g., via one or more machine learning techniques) that a subset of the acoustic spaces 708a, 708b, and 708c is the combination acoustic space 708d. The combination acoustic space 708d can be utilized to drive enhanced user experiences. For example, the combination acoustic space can be used to group the network devices 704a, 704b, and 704c into a bonded group.

In some examples, acoustics spaces and combination acoustic spaces, such as those illustrated and described above with reference to FIGS. 7B-7E can be setup and configured via interaction between a user (e.g., the user 706) and a user interface of a controller (e.g., the user interface 440 of the control device 104 of FIG. 4). In these examples, the controller may render visual representations of acoustic spaces and configure/reconfigure the acoustics spaces based on tactile or other input provided by the user. Acoustic spaces setup in this manner may facilitate other functions, such as zone creation, playback device placement, or the like via the controller.

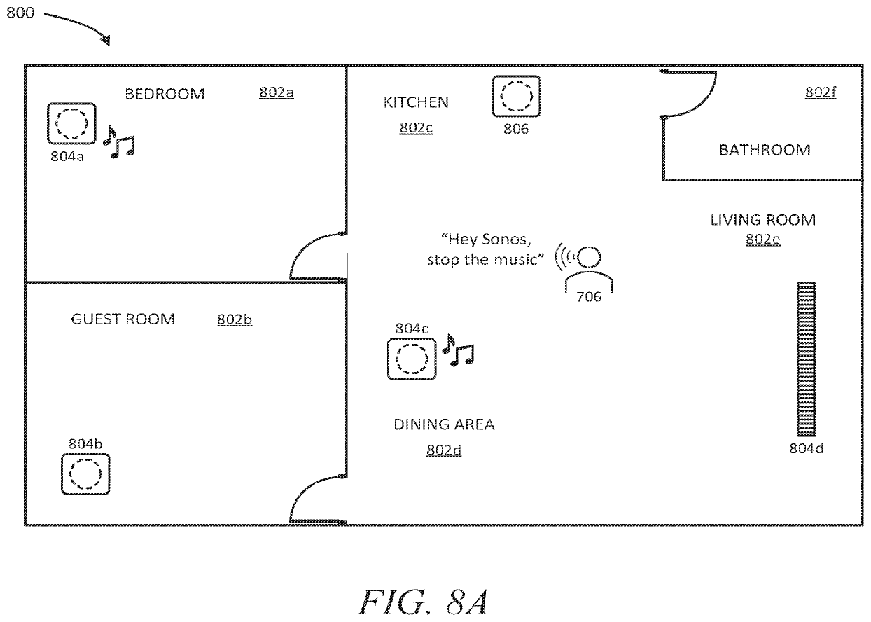

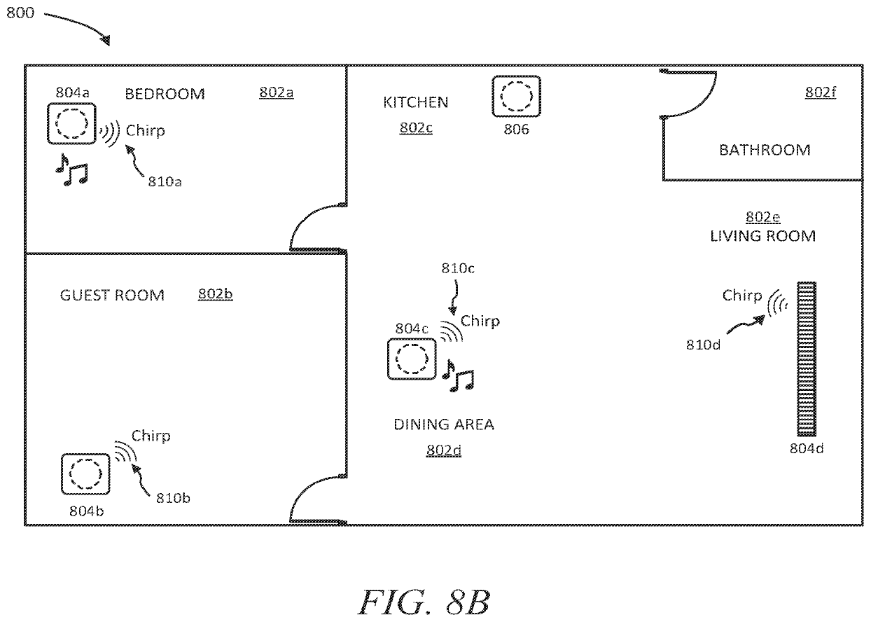

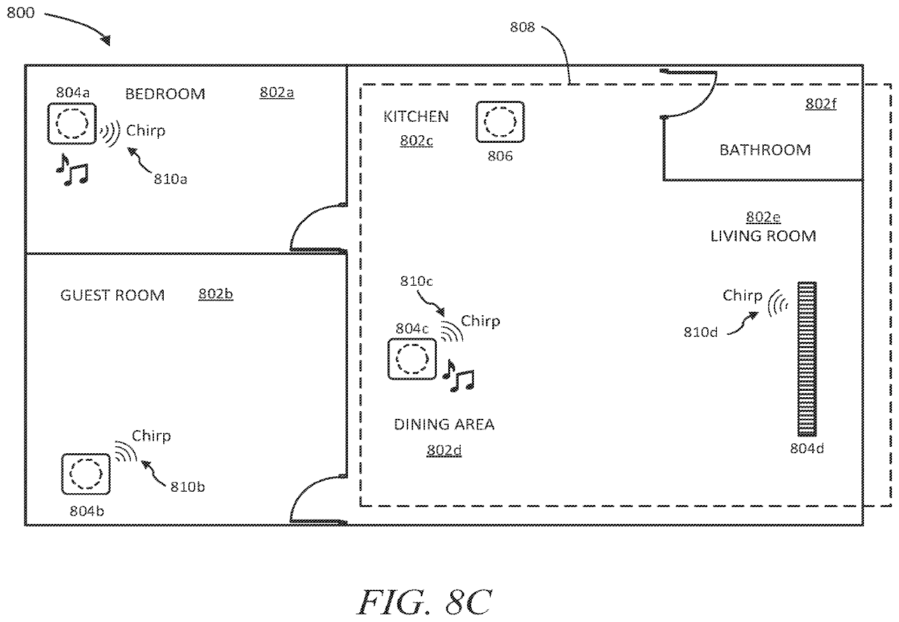

Referring to FIGS. 8A-C, there is illustrated another example of an environment 800 (e.g., environment 101 discussed above) in which a media playback system (e.g., such as MPS 100 discussed above) including a plurality of network devices is installed and in which voice command disambiguation techniques according to certain examples can be implemented. In the illustrated example, the environment 800 includes several rooms and spaces identified as Bedroom 802a, Guest Room 802b, Kitchen 802c, Dining Area 802d, Living Room 802e, and Bathroom 802f; however, it is to be appreciated that the environment 800 may include additional, fewer, or other rooms/spaces (e.g., as shown in FIG. 1A or 7A-E), and the example shown in FIGS. 8A-C is for purposes of illustration only. In the illustrated example, the media playback system includes a plurality of network devices 804 (identified individually as 804a-d), which may correspond to any of the playback devices 102 and/or NMDs 103 discussed above. The media playback system further includes another network device 806, which for the purposes of the illustrative examples discussed below is designated as the listening device 806. The listening device 806 may be an NMD-equipped playback device, a standalone NMD (such as an NMD 103 discussed above), or a voice-enabled controller device (such as a controller device 104 discussed above). The media playback system may include additional playback devices, NMDs, and/or controller devices not shown in FIGS. 8A-C. Further, in other examples, the media playback system may include fewer than four network devices 804.

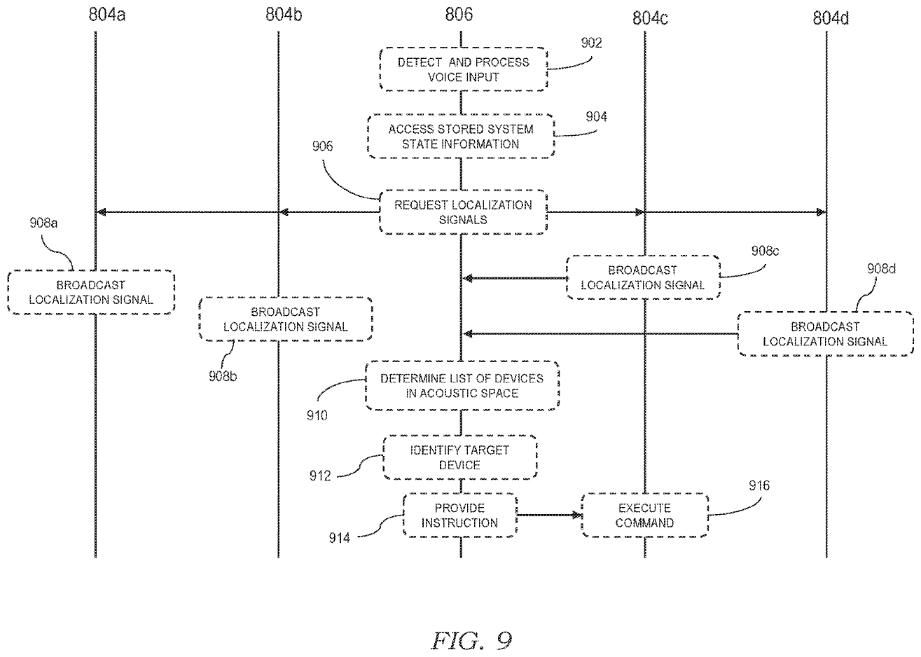

FIG. 9 is a sequence diagram corresponding to an example of voice command disambiguation by determining an acoustic space 808 of the listening device 806 in the environment 800 of FIGS. 8A-C. Various actions in the process described with reference to FIG. 9 may be ascribed to the listening device 806; however, as discussed above, in other examples the various actions (or parts thereof) may be performed by any one or more network devices 804 alone or in combination with one or more other network devices 804 and not limited to the listening device 806 itself.

Referring to FIGS. 8A and 9, as indicated at block 902, the listening device 806 detects a voice input uttered by a user 706. The voice input may contain an ambiguous voice command. For example, as illustrated in FIG. 8A, two network devices 804a, 804c may both be playing back audio content and the user 706 may give a voice command to “stop the music” without identifying the target network device 804 for the voice command. As such, the media playback system may not have sufficient information by which to determine which network device, 804a or 804c, should be instructed to execute the voice command (i.e., stop playing music).

Further, in order to determine what action to take based on the voice input, the listening device 806 may process the voice input (as indicated at block 902) to extract the voice command and determine an intent of the voice command, as discussed above with reference to FIGS. 1B and 5. Thus, in the present example, the listening device 806 may determine that the intent of the voice command is to have a network device 804 stop playing music, although which network device may be presently unknown. The listening device 806 may also correlate the intent of the voice command (i.e., to stop music that is playing) with those network devices 804 that have a context that matches the intent of the voice command. For example, in the above-discussed scenario, the network devices 804a and 804c are playing music and therefore have a context (playing music) that matches, or is relevant to, the intent of the voice command (i.e., to stop the music that is playing), whereas the network devices 804b and 804d do not.

In addition, in certain examples, one or more of the network devices 804 that are in proximity to the listening device 806 and/or the user 706 may be NMD-equipped playback devices and therefore may also detect the voice input uttered by the user 706. Accordingly, the listening device 806 and any one or more NMD-equipped network devices 804 that detect the voice input may facilitate arbitration amongst one another, as discussed above, to identify the listening device 806 (in this example, but more generally, which network device of those that detected the voice input) as the device responsible for processing the voice input and optionally communicating with a VAS if not locally hosted on the listening device 806. Examples of arbitrating between network devices are provided, for example, in previously referenced U.S. Pat. No. 10,499,146.

According to certain examples, the listening device 806 may access stored system state information (block 904) to determine that both network devices 804a and 804c are playing audio content. At various times, system state information may be communicated between one or more network devices 804, including the listening device 806. In certain examples, the listening device 806 may acquire and store the system state information. In other examples, the listening device 806 may query one or more of the network devices 804 to determine the system state information. In certain examples, the system state information may include information such as which network devices 804 are playing audio content at any given time, that two or more network devices 804 are playing audio content in synchrony, a type of audio content being played by any of the network devices 804 (e.g., music, a podcast, or home theatre audio, for example), or that two or more of the network devices 804 are presently part of a bonded group, to name a few examples. In various examples, the system state information may include any information relating to one or more of the network devices 804a-d that may be useful in disambiguating voice commands received by the listening device 806. Based on the accessed system state information, the listening device 806 may determine that the network devices 804a and 804c are both playing music, and therefore that additional information may be required to determine which of the network devices 804a, 804c the user 706 wants to stop playing the music.

According to one example, the listening device 806 may transmit an instruction (block 906) to cause the network devices 804a-d to broadcast localization signals, or “presence alert” signals, that the listening device 806 can use to determine its acoustic space. Upon receiving the instruction from the listening device 806, the network devices 804a-d may each broadcast a localization signal 810 (identified individually as signals 810a-d), as shown in FIG. 8B and indicated at blocks 908a-d in FIG. 9. To transmit the instruction, broadcast the localization signals, and detect the localization signals using an appropriate wireless communications and/or sensing capability, the network devices 804 and the listening device 806 may each host an instance of the positioning system application 600 discussed above. Through the positioning system application 600, the listening device 806 and the network devices 804 may communicate among one another using any of various communications/sensing technologies and capabilities in support of one or more application capabilities of the media playback system, including the determination of acoustic spaces that can be used to disambiguate voice commands. In particular, in certain examples, the listening device 806 can detect the localization signals 810 from one or more network devices 804, thereby detecting the presence of those one or more network devices 804, which may indicate that the one or more network devices 804 are in the same acoustic space as the listening device 806.

According to certain embodiments, the localization signals 810 may be audio signals (e.g., ultrasound signals) or radio frequency (RF) signals (e.g., via WI-FI, BLUETOOTH, UWB, or another radio frequency communications technique). Similarly, the instruction to broadcast the localization signals 810 may be sent from the listening device 806 to the network devices 804 using audio or RF communications, for example in the form of a broadcast signal. In some instances, the instruction to broadcast the localization signals 810 may be sent from the listening device 806 to any other device in the system, such as a controller or other playback devices, which can in turn instruct the other playback devices to broadcast the localization signals 810. In some instances, the instruction to broadcast the localization signals 810 may be sent from the listening device 806 to any other device working in association with the system, such as a cloud computing device and/or any of the computing devices 106 described with reference to FIG. 1B, which can in turn instruct the other network devices 804 to broadcast the localization signals 810. In certain examples, because the localization signals 810 are used by the listening device 806 to determine whether or not any of the network devices 804 are within the same acoustic space as the listening device 806, it may be preferable that the localization signals 810 are audio signals. In some examples; however, the localization signals 810 may be transmitted using another type of “short range” or optionally line-of-sight technology, such as UWB. In contrast, the broadcast instruction sent by the listening device 806 may be transmitted using a longer-range technology, such as WI-FI, for example, to ensure that all network devices 804 in an area surrounding the listening device 806 that is at least as large as the acoustic space will receive the instruction.

In certain examples, the localization signals 810 are audio signals, such as acoustic chirps, that can be detected by the microphone(s) (e.g., microphone(s) 222) of the listening device 806. The audio signals may be ultrasonic signals, for example. An audio signal can be represented by a time-frequency representation, having identifiable acoustic characteristics or patterns (such as one or more tones of particular frequencies or symbols) over time. To enable identification of the transmitting network device 804, the time-frequency representation of the audio signal can be unique to each playback device transmitting the audio signal. For example, the audio signal may include an identifier or a code for the playback device playing the audio signal. Each encoded identifier may be different and encoded as a set of tones, for example. Each tone or symbol can be in the form of a pulse where the tone has a duration, envelope length, and a guard interval. The duration of a particular tone can be the time between the beginning and end of the pulse (e.g., 5-15 milliseconds), and the envelope length can be the length of time that pulse takes to reach maximum magnitude from zero (e.g., 1-10 milliseconds). The guard interval (i.e. an interval of time) is a period of silence between each tone or before the following tone (e.g., 10-50 milliseconds, such as between about 30-50 milliseconds). Thus, upon detection of an audio signal corresponding to a localization signal 810 from each respective network device 804, the listening device 806 can identify the particular network devices 804 as the source of the respective audio signal. This may be particularly relevant for matching the determined intent of the voice command to a context of one or more network devices 804, as discussed above and further below. Additional examples and details regarding presence detection using audio signals, and in particular, ultrasound signals, are disclosed in U.S. Patent Publication Nos. 2022/0066008 and 2022/0261212 referenced above.

As noted above, in other examples, the localization signals 810 may be implemented using other communications technologies, such as line-of-sight signal reception techniques (e.g., UWB signals). In some examples, the localization signals 810 may be radio frequency signals transmitted via WI-FI or BLUETOOTH, for example. According to certain embodiments, it may be preferable to use relatively short-range signals, such as ultrasound, BLUETOOTH, or UWB signals, for the localization signals 810 in order to obtain a more accurate determination of the acoustic space surrounding the listening device 806. However, signal strength measurements, such as RSSI measurements, may also be used to increase precision whether short-range or longer-range signal types are used. For example, referring again to FIG. 8B, the listening device 806 may detect higher RSSI for a received localization signal 810c from a nearby and unobstructed network device 804c versus a localization signal 810a from the network device 804a that, if received at all, may have lower RSSI due to the further distance and obstructing wall between the listening device 806 and the network device 804a.

U.S. Patent Publication No. 2022/0066008 referenced above discloses examples of determining which playback device out of a plurality of playback devices is closest to a listening device using techniques applicable to audio signals and as may be applied to the present disclosure, as will be appreciated by those skilled in the art. Further, U.S. Patent Publication Nos. 2021/0099736 and 2021/0297168 referenced above provide examples of using RSSI measurements to obtain positional information, which may also be applied to the acoustic space determination techniques disclosed herein, as will be appreciated by those skilled in the art.

Referring to FIGS. 8C and 9, in certain examples, the listening device 806 may detect the localization signals 810c, 810d transmitted by the network devices 804c, 804d, respectively, and based on detection of the localization signals 810c, 810d, determine that the network devices 804c and 804d are in the same acoustic space 808 as the listening device 806 (block 910). In contrast, the listening device 806 may not detect the localization signals 810a, 810b transmitted by the network devices 804a, 804b, respectively. As a result, the network devices 804a and 804b may be excluded from the acoustic space 808. In certain examples, detection of the localization signals 810 may be based on detecting the localization signals with a signal strength above a certain, configurable, threshold value, e.g., >=−70 dBm, >=−80 dBm, or >=−90 dBm, etc. For example, the listening device 806 may detect the localization signal 810a transmitted by the network device 804a, but with such low signal strength (e.g., due to the distance and/or the obstructing wall between the listening device 806 and the network device 804a) that the localization signal 810a is not identified as having been “detected” by the listening device 806 and/or the network device 804a is not identified as being in the same acoustic space 808 as the listening device 806.

Thus, at block 910 in FIG. 9, the listening device 806 determines a list of network devices 804 that are within the acoustic space 808 based on the detected localization signals 810. As discussed above, determining the acoustic space 808 includes determining a list of one or more network devices 804 that are considered to be within the acoustic space 808 of the listening device 806, and therefore of the user 706. Accordingly, the listening device 806 does not determine boundaries of the acoustic space 808, but rather, based on detecting the presence of the network devices 804c, 804d (through detection of the localization signals 810c, 810d), determines that its acoustic space 808 includes a list of network devices that comprises the network devices 804c, 804d.

As discussed above, in certain examples, based on the listening device 806 having detected the voice input uttered by the user 706, the listening device 806 may infer that the acoustic space 808 of the listening device 806 approximates the acoustic space of the user 706. Accordingly, in the example of FIGS. 8A-C, the listening device 806 may infer that the network devices 804c, 804d are in the acoustic space of the user 706, and therefore that one of the network devices 804c, 804d is the intended target device for the voice command.

As discussed above, the listening device 806 may determine the intent of the voice command and identify those network devices 804 that have a context that matches the intent of the voice command. In some instances, correlation between the intent of the voice command and the context(s) of the network devices 804 may be done prior to determination of the list of network devices 804 in the acoustic space 808. In other examples, after identifying those network devices 804c, 804d that are included within the acoustic space 808, the listening device 806 may determine which, if any, have a context that matches the intent of the voice command. As discussed above, in certain examples, the listening device may determine the context(s) of the network devices 804 based on system state information that can be acquired or accessed by listening device 806. In the example of FIGS. 8A-C, the network device 804c is playing audio content whereas the network device 804d is not. Accordingly, the listening device 806 may determine that the network device 804c has a context that matches the intent of the voice command to “stop the music” whereas the network device 804d does not. Thus, even though the network device 804d is in the acoustic space 808, it can be eliminated as a potential target device for the voice command based on the lack of a match between the context(s) of the network device 804d and the intent of the voice command.

Accordingly, the listening device 806 may identify the network device 804c as the intended target device (indicated at block 912 in FIG. 9). The listening device 806 may then issue an instruction (indicated at block 914) to the network device 804c to execute the voice command. The network device 804c may receive the instruction and execute the voice command, as indicated at block 916. In some instances, the instruction to execute the voice command can be sent directly from the listening device 806 to the network device 804c. In some instances, the instruction to execute the voice command can be sent to the network device 804c through other devices in the system (e.g., other playback devices, controllers, etc.) or devices otherwise operating in association with the system (e.g., cloud computing device, computing devices 106, etc.).

It will be appreciated, given the benefit of this disclosure, that numerous other examples and scenarios may occur and be implemented in accord with the principles disclosed herein.

In certain examples, the listening device 806 may also be a potential target device for the voice command. For example, in certain circumstances wherein the listening device 806 is an NMD-equipped playback device, the listening device may also be playing audio content at the time the user 706 gives the voice command to “stop the music.” In such circumstances, the listening device 806 may simply execute the voice command, or may obtain additional information to determine a most likely intended target device. For example, the listening device 806 may determine that the network device 804c is in the same acoustic space 808, as discussed above, and that the network device 804c has a context that also matches the intent of the voice command (e.g., playing music). In some instances, based on determining that both the listening device 806 and the network device 804c are in the acoustic space 808 of the user 706 and have contexts that match the intent of the voice command, the listening device may conclude that the user 706 intended both the listening device 806 and the network device 804c to execute the voice command, and proceed accordingly. In other examples, the listening device 806 may use system state information, as discussed above, to obtain other information that may assist the listening device 806 in disambiguating the voice command and determining whether the listening device 806, the network device 804c, or both, is/are the intended target device. For example, the listening device 806 may process the voice input to identify the current user 706 issuing the voice command (e.g., as discussed above with reference to FIGS. 1B and 2A, for example), and access system state information that identifies the current user as the same user who previously gave a playback command to start audio playback on the network device 804c. Based on this historical information, the listening device 806 may conclude that the network device 804c is the intended target device and proceed accordingly. As will be appreciated by those skilled in the art, given the benefit of this disclosure, numerous other variations and scenarios are possible in accord with the aspects, examples, and principles disclosed herein.

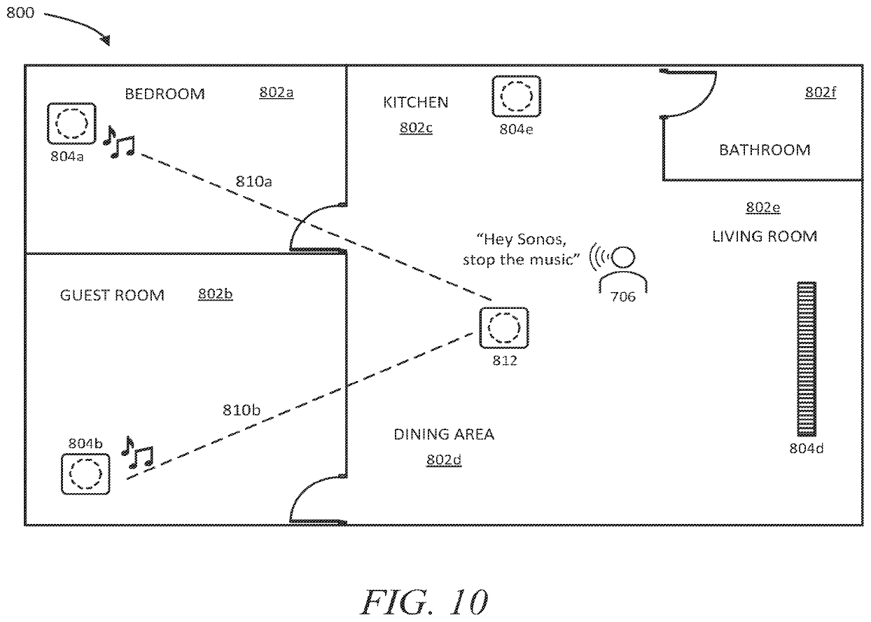

Referring to FIG. 10, there is illustrated another example of the environment 800 in which network device 804a located in the Bedroom 802a and the network device 804b located in the Guest Room 802b are both playing music at the time at which the user 706 utters a voice command to “stop the music.” In this example, the media playback system further includes a network device 804e located in the Kitchen 802c and a listening device 812 located in the Dining Area 802d. As discussed above, the listening device 812 may be an NMD-equipped playback device or a standalone NMD. The listening device 812 detects the voice input from the user 706 and implements a voice command disambiguation process as discussed above to determine the target device.

In the example of FIG. 10, the listening device 812 may receive localization signals 810a and 810b from the network devices 804a and 804b, respectively, as shown. Accordingly, based on detecting the presence of both the network devices 804a, 804b through the localization signals 810a, 810b, the listening device 812 may determine that these playback devices are both within the acoustic space of the user 706, as discussed above. The listening device 812 may also determine that both network devices 804a, 804b have contexts (e.g., are playing music) that matches the intent of the voice command uttered by the user 706. Accordingly, in certain examples, the listening device 812 may instruct both network devices 804a, 804b to execute the voice command.

In other examples, the listening device 812 may consider additional factors to determine the target device(s). For example, although the network devices 804a, 804b are positioned relatively equidistant from the listening device 812 in the example shown in FIG. 10, there may be a difference in signal strength between the two detected localization signals 810a, 810b because the localization signal 810a has a clear path to the listening device 812 whereas the localization signal 810b passes through an obstruction (the wall between the Guest Room 802b and the Dining Area 802d). Accordingly, the listening device 812 may use this difference in signal strength to identify either the network device 804a (potentially heard more loudly by the user 706) or the network device 804b as the intended target device. In some examples, another factor that may be considered by the listening device 812 in identifying the target device(s) is the identity of the user 706. For example, as discussed further below, the listening device 812 may determine whether the current user 706 giving the voice command is the same user who started playback of the music playing on either (or both) network devices 804a, 804b and use this information to select one or both network devices 804a, 804b as the target device. In some examples, another factor that may be considered by the listening device 812 in identifying the target device(s) is a role or context of the listening device itself. For example, if the listening device 812 is a voice-enabled controller device, a command to “stop the music” may be interpreted to mean that the user wishes to stop all music on all playback devices in the media playback device. In some examples, such a command received by a controller device may be executed without going through the process of determining the acoustic space.

Thus, various factors may be considered in combination with determination of the acoustic space or independently thereof. In certain examples, the software code 214 (FIG. 2A) stored in the memory 213 and executable by the processor 212 may include instructions that are configured to define what factors the listening device 812 may consider in different scenarios and how the listening device 812 identifies the target device(s) in various scenarios based on one or more factors and/or collected information about the network devices 804 determined to be in the acoustic space of the user 706.

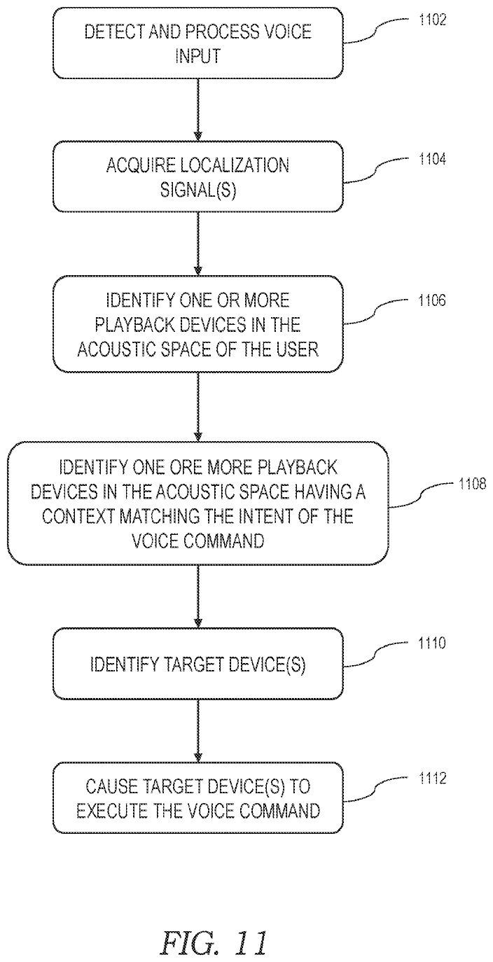

FIG. 11 is a flow diagram illustrating an example of a method of voice command disambiguation based on acoustic space according to certain aspects. At step 1102, a listening device detects a voice input from a user and processes the voice input to extract a voice command and determine an intent of the voice command. The voice command may be ambiguous in that it does not specify a target device to execute the voice command to fulfil the intent. Accordingly, at step 1104, the listening device may broadcast an instruction for all playback devices that receive the instruction to broadcast localization signals. As discussed above, the localization signals may be audio signals or other signals that are useful for determining an acoustic space surrounding the listening device. The listening device may detect one or more of the localization signals, thus detecting the presence of one or more corresponding playback devices. Based on detecting the localization signal(s), the listening device may identify one or more playback devices that are determined to be within the acoustic space of the listening device, and therefore within the acoustic space of the user who uttered the voice input detected by the listening device in step 1102 (step 1106).

In step 1108, the listening device may identify one or more playback devices within the acoustic space (i.e., from the list of the playback devices detected in step 1106) that have a context that matches the intent of the voice command. As discussed above, the listening device may acquire or access system state information from one or more network devices in the media playback system to make this identification. At step 1110, the listening device may identify one or more target devices for the voice command. As discussed above, the listening device may identify the target device(s) based on the target device(s) being in the acoustic space of the user and having a context that matches the intent of the voice command. The listening device itself may be a potential target device. In certain examples in which there are two or more potential target devices that meet these criteria, the listening device may consider additional factors, as described above, to select one or more devices from the list of potential target devices. In other examples, in this scenario, the listening device may determine that all two or more potential target devices are the intended target devices. At step 1112, the listening device causes the identified target device(s) to execute the voice command.

As discussed above, certain aspects provide for detecting and tracking one or more voice signatures associated with voice commands given to the media playback system, and using the voice signatures, together with contextual information, to disambiguate certain voice commands. As noted above, the voice signatures maybe unique to specific users, but need not identify or be associated with any particular user information, such that user privacy may be maintained even as the voice signature(s) are monitored. Further, the voice signature(s) may be temporary in that they are only stored within the system for relatively short periods of time (e.g., a few minutes or hours), which may have both privacy and system efficacy benefits. According to certain aspects, disambiguation techniques use a combination of voice signature matching and acoustic space determination.

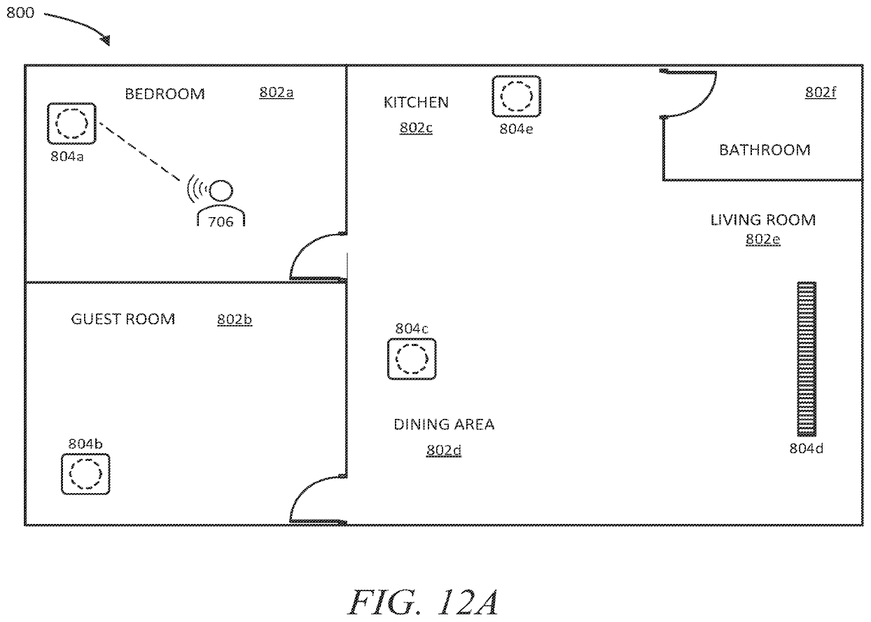

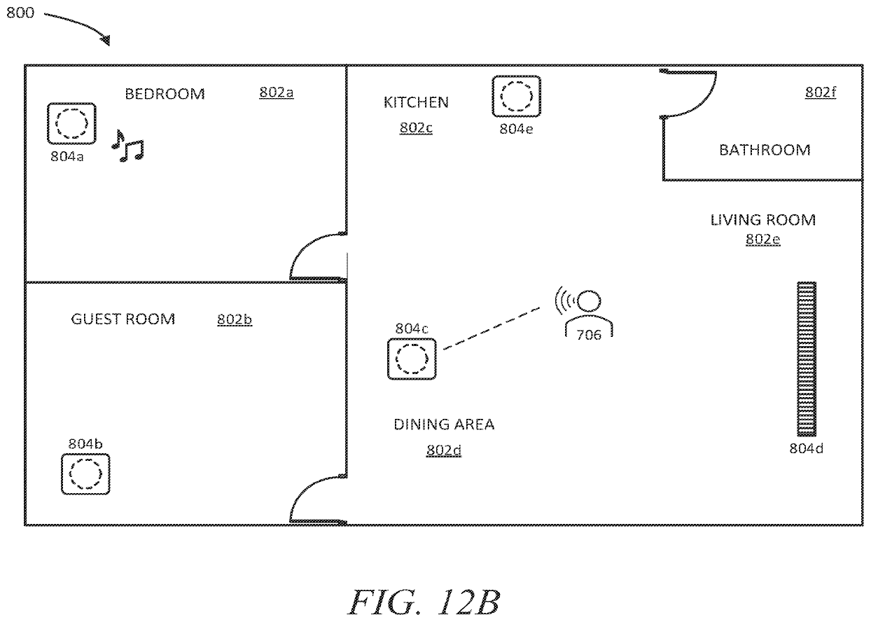

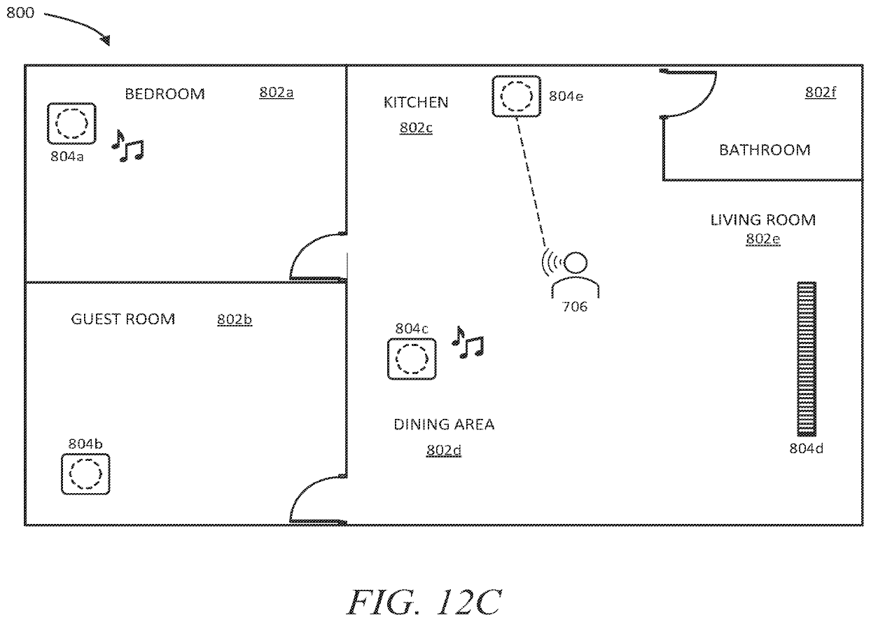

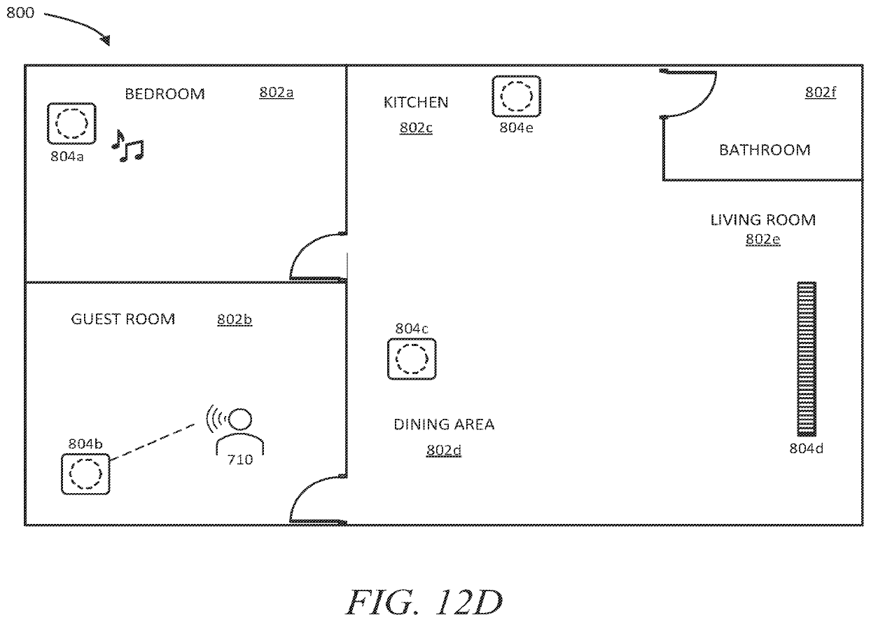

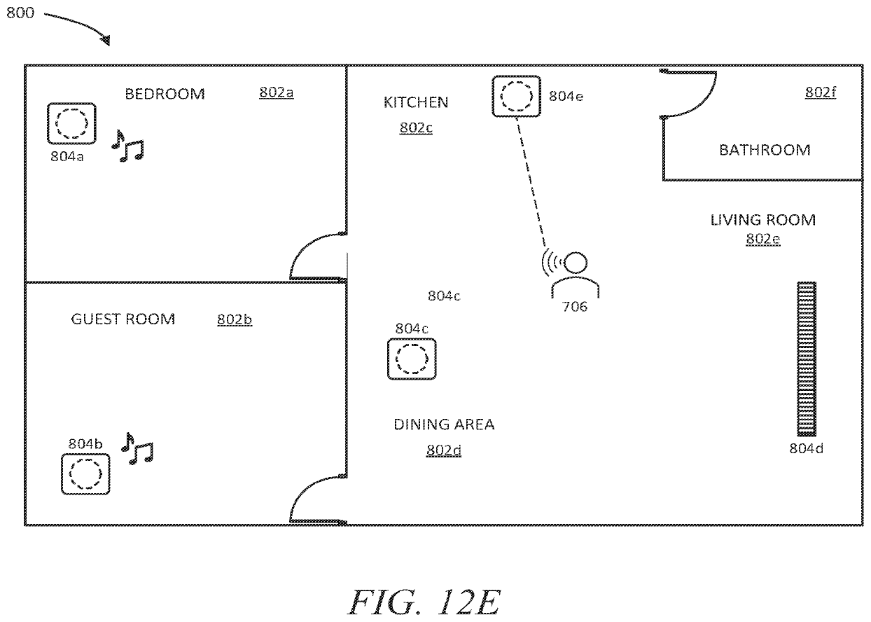

FIGS. 12A-E illustrate an example of using voice signature tracking and correlation for voice input disambiguation in the environment 800.

Referring to FIG. 12A, in this example, the user 706 utters a first voice input containing a first voice command that instructs the network device 804a to begin playback of first audio content. The media playback system may further process the first voice input from the user 706 to identify a unique voice signature associated with the voice input, and store this first voice signature along with association information that associates the first voice signature with the first voice command and the network device that executed the voice command (network device 804a in the example of FIG. 12A). The voice signature and association information may be stored in a data structure in the memory 213, for example. Thus, in one example, the association information may specify that the network device 804a executed the first voice command to begin playback of the first audio content, the first voice command being associated with voice input having a first voice signature. By storing this information, the media playback system may later determine whether further voice inputs have the same or different voice signatures.

Referring to FIG. 12B, at a later time while the network device 804a is playing the audio content initiated by the first voice command from the user 706, the user 706 may initiate playback of different audio content on network device 804c in the Dining Area 802d. In the illustrated example, the user 706 initiates playback of the second audio content on the network device 804c by issuing a second voice command that is detected and processed by one or more network devices 804, as discussed above. Accordingly, the media playback system may identify that the second voice command has the same voice signature as did the first voice command. Accordingly, the media playback system may update the association information to further associate the second voice command and the network device 804c with the first voice signature. In particular, the updated association information may further specify that the network device 804c executed the second voice command to begin playback of the second audio content, and that the second voice command was also associated with the first voice signature. In certain examples, the association information may also include timing information, which may be absolute or relative. For example, the media playback system may store timing information that indicates that the second voice command was received after the voice command, or that each voice command was received at a particular respective time of day, for example. Such timing information may be useful in assisting the media playback system to disambiguate subsequent voice commands, as discussed further below.

Referring to FIG. 12C, at a later time while the network devices 804a and 804c are still playing the first and second audio content, respectively, the user 706 may give a third, ambiguous voice command. For example, the user 706 may say “stop the music” without specifying a target network device 804 that is intended to execute the voice command. In the example illustrated in FIG. 12C, network devices 804a and 804c are both playing audio. In addition, the user's voice input may be detected by a network device (e.g., network device 804e in the example illustrated in FIG. 12C) that is not either of the network devices 804a, 804c that are presently playing back audio. Thus, without further information, the media playback system may have no way to provide correct feedback (i.e., correctly execute the voice command in accord with the user's intent). For example, based on the user's location proximate the Dining Area 802d, if the network device 804c is an NMD-equipped playback device and detects the voice input from the user 706, given that the network device 804c is playing audio in this example, the voice command “stop the music” received at the network device 804c may not be considered ambiguous. However, network device 804e (detecting the voice input in the example of FIG. 12C) may require additional information to correctly determine the intent of the voice command and cause the correct network device(s) 804a and/or 804c, to execute the command.

Accordingly, as described above, in some examples, the system may correlate the intent of the voice command (i.e., to stop music that is playing) with those network devices 804 that have a context that matches the intent of the voice command. For example, in the scenario of FIG. 12C, the network devices 804a and 804c are playing music and therefore have a context (playing music) that matches, or is relevant to, the intent of the voice command (i.e., to stop the music that is playing), whereas the network devices 804b, 804d and 804e do not.

According to certain aspects, the media playback system may process the voice input containing the third voice command and determine that the voice input matches the stored first voice signature. Accordingly, the system may access the association information stored with the first voice signature and use this information to determine the manner in which to execute the third voice command. For example, if the association information indicates that the user 706 very recently (e.g., within a few minutes ago) started playback of the second audio content on the network device 804d, the system may infer that the user wishes to continue with this playback and that the intent of the third voice command is to stop playback of the audio content on the network device 804a in the Bedroom 802a because the user 706 has moved away from the Bedroom 802a. Therefore, the system may infer that the target device is the network device 804a, and cause the network device 804a to stop playback of the first audio content. In another example, because the association information indicates that playback of both the first audio content on the network device 804a in the Bedroom 802a and the second audio content on the network device 804c in the Dining Area 802d were initiated by voice commands associated with the first voice signature, the system may infer that the intent of the third voice command is to stop playback on both playback devices 804a and 804c. In certain examples, the software code 214 (FIG. 2A) stored in the memory 213 and executable by the processor 212 may include instructions that are configured to provide rules as to how the media playback system may make various inferences based on the association information to identify the target device(s) in different scenarios.

Referring to FIG. 12D, in another example, after the user 706 has initiated playback of the first audio content by the network device 804a (FIG. 12A), and while the network device 804a is playing the first audio content, another user 710 may initiate playback of different audio content (the second audio content in this example) on network device 804b in the Guest Room 802b via a voice command. The network device 804b, and/or another network device 804 in the media playback system, may detect voice input from the second user 710 and process the voice input to cause the network device 804b to execute the voice command and begin playback of the second audio content. As discussed above, the media playback system may further process the voice input from the second user 710 to identify a second voice signature. By comparing the second voice signature identified in the voice input from the second user 710 with the stored first voice signature identified in the voice input from the first user 706, the system may determine that the two voice signatures are different. Accordingly, the system may store the second voice signature with association information that associates the second voice signature with the second voice command and the network device 804b.

Referring to FIG. 12E, at a later time while the playback devices 804a and 804b are still playing the first and second audio content, respectively, the first user 706 may give a third, ambiguous voice command, similar to the scenario discussed above with reference to FIG. 12C. For example, the first user 706 may say “stop the music” without specifying a target network device 804 that is intended to execute the voice command. In the example illustrated in FIG. 12E, network devices 804a and 804b are both playing audio. As in the example discussed above with reference to FIG. 12C, in this example, the voice input from the first user 706 containing the third voice command may be detected by the network device 804e, and therefore may apply to either network device 804a, 804b that is presently playing back audio content. However, in this example, the system may determine that the voice signature associated with the ambiguous third voice command matches the first voice signature but not the second voice signature. By tracking the voice signatures, the system can make an inference as to where to stop playback. For example, because the same user 706 had previously initiated playback in the Bedroom 802a, it may make sense to stop playback in the Bedroom 802a rather than in the Guest Room 802b, where another user 710 has initiated playback. Accordingly, based on the association information stored with the first voice signature, which indicates that the first voice command caused the network device 804a to play back the first audio content, the system may infer that the target device for the third voice command is the network device 804a, and cause the network device 804a to stop playback of the first audio content.

It will be appreciated, given the benefit of this disclosure, that there are numerous other examples and scenarios beyond those discussed above with reference to FIGS. 12A-E. Embodiments of the media playback system may track voice signatures and make determinations based on matches, or lack thereof, between detected voice signatures and based on stored association information correlated with one or more voice signatures in all such examples and scenarios. In addition, the system may access and use stored system state information as well as the association information in some examples. As described above, the system state information may include any information relating to one or more of the network devices 804a-e (e.g., which network devices 804 are playing audio content at any given time, that two or more network devices 804 are playing audio content in synchrony, a type of audio content being played by any of the playback devices 804, that two or more of the playback devices 804 are presently part of a bonded group, etc.) that may be useful in disambiguating voice commands received by a listening device. Association information may include certain system state information that is associated with a stored voice signature. However, system state information that is not necessarily linked to a particular voice signature may nonetheless be useful in disambiguating certain voice commands. Accordingly, embodiments of the system may use general system state information as well as association information in identifying potential target devices.

As discussed above, the media playback system may be provided with software instructions that control how the media playback system identifies one or more target network devices for ambiguous voice commands based on the association information and various factors that are represented by the association information and/or other system state variables. For example, as discussed above, timing information (e.g., one playback device started playback of audio content more recently than another) that may be part of the association information may be a factor that is used. In another example, location or positional information for the user(s) and/or one or more network devices may be considered, as discussed further below. In another example, the contexts of various network devices in the media playback system (e.g., which playback devices are currently playing back audio content, or which network devices are part of a particular bonded group) may be considered. For example, referring to FIG. 12C, in the illustrated example, the network device 804e is not playing audio and therefore, the system may conclude that a voice command of “stop the music” is not intended for the network device 804e. Accordingly, in certain examples, the media playback system may use system state information, such as which playback devices 804 are playing audio versus which are not, and various other information regarding the contexts of the various network devices in the media playback system, to further assist in disambiguating voice commands, as discussed in more detail below. These and other factors may be used, individually or in various combinations, to disambiguate certain voice commands according to processes encoded in the software 214.

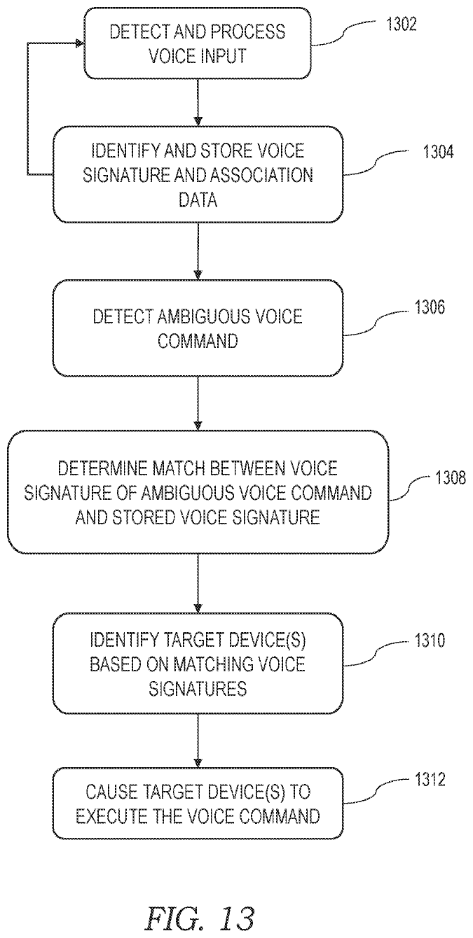

FIG. 13 is a flow diagram illustrating an example of a method of disambiguating a voice command using tracked voice signatures and association information according to certain aspects. As discussed above, at step 1302 the media playback system may detect and process voice input from a user. At step 1304, the system identifies a unique voice signature associated with the voice input and stores the voice signature along with association information that associates the voice signature with system state information. As discussed above, the system state information may include information about a voice command that was included in the voice input, information that identifies one or more network devices in the media playback system that executed the voice command, timing information about when the voice command was executed by the one or more network devices, and/or information relating to the context(s) of the one or more network devices that was/were altered by execution of the voice command. For example, if the system receives voice input with a voice command that directs playback device Pa to begin playback of audio content Ca, the association information may include information that identifies the playback device Pa and the audio content Ca, and optionally timing information. Thus, the system may store a record that, at time Ta, voice signature A caused playback device Pa to play back audio content Ca.

The system may repeat steps 1302 and 1304 over time as various voice inputs having the same or different voice signatures are detected and processed. If the system detects voice input(s) having a voice signature that matches a stored voice signature, the system may update the association information stored with that voice signature. As discussed above, determining whether a detected voice signature matches a stored voice signature may include comparing the detected voice signature with the stored voice signature. For example, continuing the example above, the system may update the association information for voice signature A to record that the volume of playback on playback device Pa was altered, that playback device Pa was directed to change the audio content from Ca to Cal, or that another playback device, Pb, was directed to begin playback of audio content Ca or Ca2, etc. In certain instances, the system may delete certain association information based on subsequent detected voice commands. For example, if at time, Tb, the system detects a voice command matching voice signature A that instructs playback device Pa to cease playback of the audio content Ca, the system may delete the association information that recorded that, at time Ta, the playback device Pa was instructed to begin playback of audio content Ca, since this information may no longer be relevant. Thus, the system, over time, may track one or more voice signatures and record and update association information for each voice signature.

At step 1306, the system may detect an ambiguous voice command, such as one that does not identify a target network device or contains some other ambiguity. For example, as discussed above, in the instance where two playback devices Pa and Pb are both playing back audio content, a voice command of “stop the music” that does not identify either playback device Pa or Pb may be considered ambiguous. To resolve this potential ambiguity, the system may process the ambiguous voice command to determine whether it has a voice signature that matches one of the stored voice signatures previously detected and associated with one or more voice commands (step 1308). Determining whether a detected voice signature matches a stored voice signature may include comparing the detected voice signature with the stored voice signature. As will be appreciated by those skilled in the art, given the benefit of this disclosure, voice signature matching may be performed using any of a variety of processes known in the art, including machine-learning based approaches. For example, the IDVOICE system provided by IDR&D of New York (having a place of business at 1350 Broadway, Suite 605 New York, NY 10018, USA) provides voice recognition/identification techniques that may be applied for voice signature matching. Matching need not require identity between two voice signatures.

At step 1310, the system may identify one or more target devices for the ambiguous voice command based at least in part on determining whether the voice signature associated with the ambiguous voice command matches one of the stored voice signatures and according to various rules and/or processes stored in the system. For example, as discussed above, if playback of audio content on playback device Pa was initiated by voice signature A, playback of audio content on playback device Pb was initiated by voice signature B, and the ambiguous voice command (e.g., “stop the music”) is associated with voice signature A, the system may identify playback device Pa as the target device.

Once one or more target devices have been identified, the system may cause the target device(s) to execute the voice command (step 1312).

Thus, aspects and embodiments provide techniques by which the media playback system can use voice signatures to disambiguate certain voice commands. As discussed above, the system may also use other information in combination with voice signature matching to disambiguate certain voice commands. For example, location or positional information relating to users and/or network devices in the media playback system may be used to assist in disambiguating voice commands and optionally also to assist in determining durations for maintaining the voice signatures in the system and when to delete a voice signature.

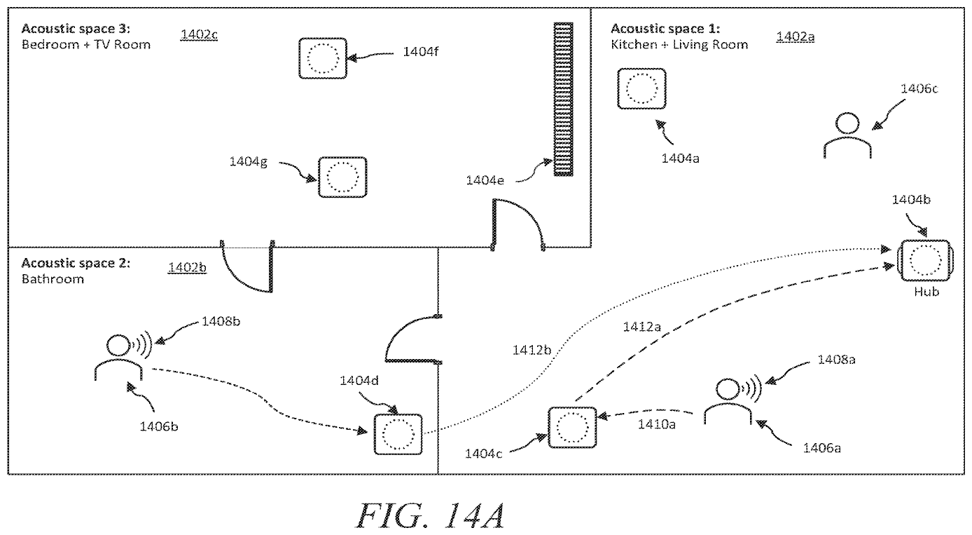

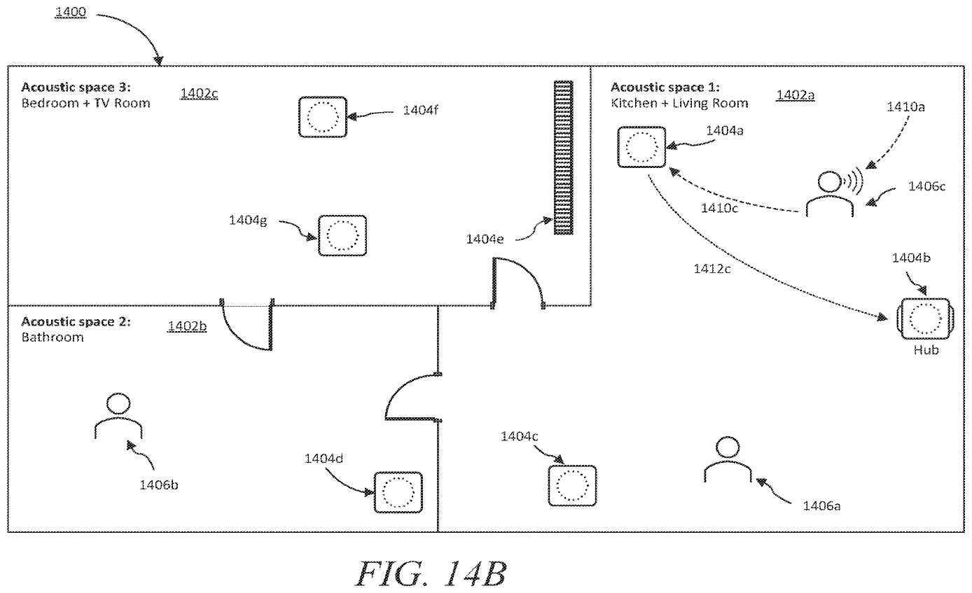

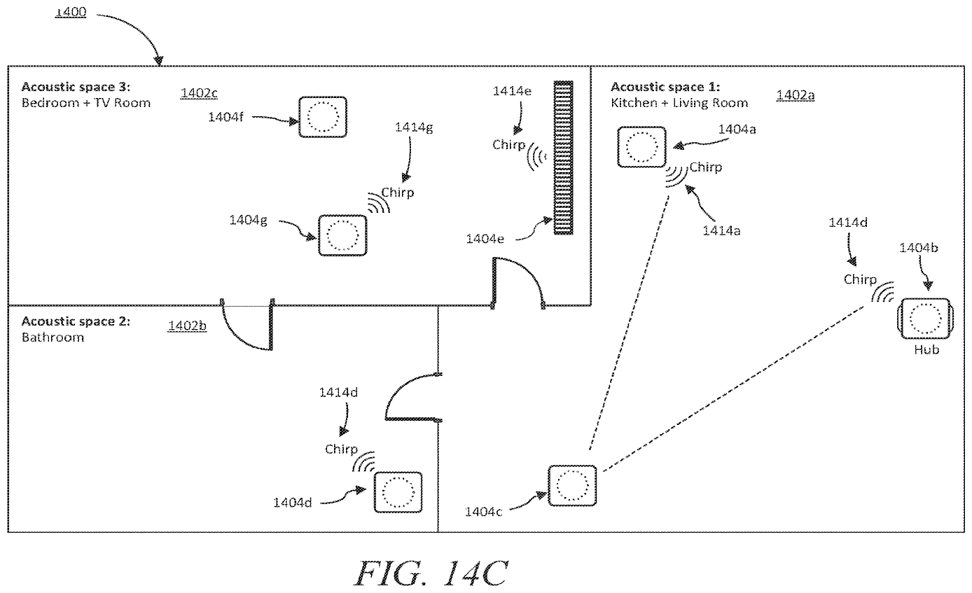

According to certain aspects, voice signature matching may be associated with acoustic spaces determined within an environment in which the media playback system is deployed, as described above. Referring to FIGS. 14A-14C, there is illustrated an example of an environment 1400 (such as the environments 101, 700, or 800 discussed above) comprising multiple acoustic spaces and in which a media playback system as discussed above may be deployed. In the illustrated example, the environment 1400 includes three acoustic spaces 1402a, 1402b, 1402c; however, the number of acoustic spaces in any given environment may depend on the layout of the environment and the number and positioning of network devices in the media playback system. Furthermore, acoustic spaces may change based on changing positions of users and/or portable network devices in the environment 1400, as described above. Accordingly, the arrangement shown in FIGS. 14A-14C is one example for the purposes of illustration and not intended to be limiting.

As described above, acoustic spaces may or may not correspond to physical rooms within the environment 1400. For example, an acoustic space may include more than one room or may include part of one or more rooms. In the illustrated example, a first acoustic space 1402a may include the Kitchen and Living Room, while a second acoustic space 1402b may include a Bathroom, and a third acoustic space 1402c may include a Bedroom and TV Room. The media playback system includes a plurality of network devices 1404 distributed throughout the environment 1400. In the illustrated example, the media playback system includes network devices 1404a, 1404b, and 1404c located in the first acoustic space 1402a, network device 1404d located in the second acoustic space 1402b, and network devices 1404e, 1404f, and 1404g located in the third acoustic space 1402c. Network devices 1404e, 1404f, and 1404g may form a bonded group, such as a home theater group, for example. Any of the network devices 1404 may be playback devices, NMD-equipped playback devices, standalone NMDs, or controller devices.

As discussed above, in certain implementations, one or more network devices 1404 in the media playback system may be designated as a hub device that performs some or all voice processing of voice inputs detected by other network devices as well as by the hub device itself. FIGS. 14A-14C illustrate an example in which the network device 1404b is designated as a hub device (referred to herein as the hub device 1404b). However, it is to be appreciated that determination of acoustic spaces, and the use of acoustic spaces in combination with voice signature matching according to aspects disclosed herein are not limited to implementation in media systems in which one or more hub devices have been designated. Accordingly, in other examples, any actions discussed below as being performed by the hub device 1404b may be performed by any network device, or combination of network devices, in the media playback system.

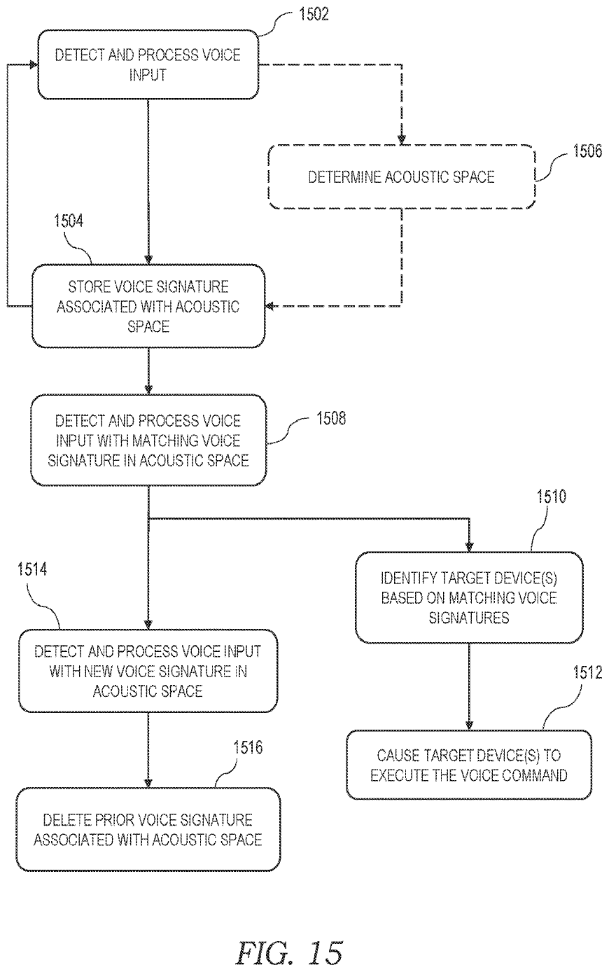

FIG. 15 is a flow diagram illustrating one example of a method of performing voice signature matching based in part on acoustic spaces in accord with aspects of the disclosure. In step 1502, the media playback system may detect and process voice input from a user. For example, referring to FIG. 14A, a first user 1406a may utter a first voice input 1408a that is detected by the network device 1404c, as indicated by arrow 1410a. In the illustrated example, the network device 1404c passes the voice input to the hub device 1404b for processing, as indicated by arrow 1412a. The hub device 1404b processes the voice input to extract a first voice command and to determine a first voice signature (corresponding to the first user 1406a) associated with the first voice input 1408a, as discussed above. The hub device 1404b may further determine an intent of the voice command and cause one or more network devices to execute the voice command to fulfill the intent, as discussed above.

In step 1504, the media playback system (e.g., via the hub device 1404b) may store the first voice signature along with association information that identifies the voice command and the one or more network devices that executed the voice command, as discussed above. In addition, the association information may identify the first acoustic space 1402a associated with the first voice signature. In certain examples, the first acoustic space 1402a may have been previously determined, for example, according to the processes and techniques described above. In other examples, the system may determine the first acoustic space in response to the network device 1404c detecting the first voice input 1408a (step 1506).

According to certain examples, in step 1506, the listening device (e.g., the network device that detected the voice input, in this example, the network device 1404c) may broadcast or otherwise send an instruction to cause the network devices 1404 to broadcast localization signals (e.g., the localization signals 810 described above), that the network device 1404c can use to determine the first acoustic space 1402a, as described above. Upon receiving the instruction from the network device 1404c, the playback devices 1404a, 1404b, 1404d, 1404e, and 1404g may each broadcast a respective localization signal 1414a, 1414b, 1414d, 1414e, 1414g, as shown in FIG. 14C. In some instances, certain network devices 1404 may not receive the instruction from the network device 1404c and therefore may not broadcast a localization signal (e.g., playback device 1404f in the example illustrated in FIG. 14C). To transmit the broadcast instruction, broadcast the localization signals, and detect the localization signals using an appropriate wireless communication and/or sensing capability, the network devices 1404 may each host an instance of the positioning system application 600 discussed above. Through the positioning system application 600, the network devices 1404 may communicate among one another and listening devices (e.g., the network device 1404c in the example of FIG. 14C) can detect the localization signals 1414 from one or more network devices 1404, thereby detecting the presence of those one or more network devices 1404, which may indicate that the one or more network devices 1404 are in the same acoustic space as the listening device. As described above, the localization signals 1414 may be audio signals (e.g., ultrasound signals) or radio frequency (RF) signals (e.g., transmitted according to WI-FI, BLUETOOTH, UWB, or another radio frequency communications technique).

Referring again to FIG. 14C, in the illustrated example, the network device 1404c may detect the localization signals 1414a, 1414b transmitted by the network devices 1404a, 1404b, respectively, and based on detection of the localization signals 1414a, 1414b, determine that the network devices 1404a and 1404b are in the same acoustic space 1402a as the network device 1404c. In contrast, the network device 1404c may not detect the localization signals 1414d, 1414e, and 1414g transmitted by the network devices 1404d, 1404e, 1404g, respectively, and therefore those devices (along with the playback device 1404f that did not transmit a localization signal) may be excluded from the first acoustic space 1402a, as shown in FIG. 14C. In certain examples, detection of the localization signals 1414 may be based on detecting the localization signals with a signal strength above a certain, configurable, threshold value, as described above. For example, the network device 1404c may detect the localization signal 1414d transmitted by the network device 1404d, but with signal strength below the threshold value such that the localization signal 1414d is not identified as having been “detected” and/or the network device 1404d is not identified as being in the first acoustic space 1402a.

Thus, the network device 1404c may determine a list of other network devices 1404 (namely network devices 1404a and 1404b in the illustrated example) that are also within the first acoustic space 1402a based on the detected localization signals 1414a, 1414b. Further, based on the network device 1404c having detected the first voice input 1408a, the system can determine that the first voice signature (identified from the first voice input 1408a) is associated with the first acoustic space 1402a. Accordingly, in step 1504 the system identifies the first acoustic space 1402 in the association information stored with the first voice signature, as discussed above.

Referring again to FIG. 15, the system may repeat steps 1502, 1504, and optionally 1506 as various voice inputs are detected at different network devices 1404 in the media playback system. The system may determine acoustic spaces 1402a, 1402b, 1402c, as needed, and store voice signatures associated with each acoustic space as such voice signatures are detected. For example, referring to FIG. 14A, a second user 1406b may utter a second voice input 1408b that is detected by the network device 1404d, as indicated by arrow 1410b. In the illustrated example, the network device 1404d passes the voice input to the hub device 1404b for processing, as indicated by arrow 1412b. The hub device 1404b processes the voice input to extract a second voice command and to determine a second voice signature (corresponding to the second user 1406b) associated with the second voice input 1408b, as discussed above. In step 1504, the hub device 1404b may store the second voice signature along with association information that identifies the voice command and one or more network devices that executed the voice command, as discussed above. In addition, the association information may identify the second acoustic space 1402b associated with the second voice signature. The second acoustic space 1402b may have been previously determined, or may be determined in step 1506, according to the processes discussed above.

At some point in time, after having stored one or more voice signatures associated with respective acoustic spaces, the system may detect a subsequent voice input having a voice signature that matches one of the stored voice signatures and is in the same acoustic space associated with the matching stored voice signature (step 1508). For example, the network device 1404c, or another network device 1404a or 1404b, in the first acoustic space 1402 may detect a subsequent voice input from the first user 1406a. Accordingly, when the system (e.g., via the hub device 1404b) processes the subsequent voice input in step 1508, the system may determine that the first voice signature is associated with the subsequent voice input and therefore with any voice commands contained therein, and that the first voice signature was detected in its associated acoustic space 1402a. In the event that a voice command contained in the subsequent voice input is ambiguous (e.g., does not identify a target network device 1404), the system may use this information, namely a matching voice signature identified in the same acoustic space 1402a, to make one or more determinations to disambiguate the voice command. For example, if an ambiguous voice command contained in the subsequent voice input does not specify a target network device, and multiple network devices 1404 in the media playback system have contexts that match an intent of the ambiguous voice command, the system may determine, based on the first voice signature having been detected in the first acoustic space 1402a with which it has been previously associated, that the intended target device is one or more of the target devices in the first acoustic space 1402a. For example, if network devices 1404a and 1404d are both playing music when the network device 1404c detects a subsequent voice input matching the first voice signature that includes a command to “stop the music” without identifying a target device, the system may determine that the intended target device is the network device 1404a because it is in the first acoustic space 1402a, whereas the network device 1404b is not.

Thus, according to certain examples, the media playback system may use the identification of matching voice signatures within associated acoustic spaces to identify one or more target devices (step 1510) for an otherwise ambiguous voice command, and cause the identified one or more target devices to execute the voice command (step 1512). In this manner, the system may use acoustic spaces and voice signature matching to autonomously disambiguate voice commands, without having to ask the user for clarification, thereby allowing users to interact with the media playback system in more streamlined and natural ways. Further, by associating voice signatures with respective acoustic spaces, the system may be able to execute otherwise ambiguous voice commands from one user without interfering with the listening experiences of other users. For example, considering the scenario discussed above, if, in response to the voice command from the first user 1406a to “stop the music,” the system were to stop playback on both the network devices 1404a and 1404d, this could disrupt the listening experience of the second user 1406b who, via the second voice input 1408b may have initiated playback of certain audio content at the network device 1404d in the second acoustic space 1402b. Instead, by confining the system response to the first acoustic space 1402a associated with the first voice signature in this scenario, the system may avoid disrupting the listening experience of the second user 1406b.

In certain examples, after having detected one or more instances of a particular voice signature in the same acoustic space, the media playback system may detect another voice signature in that acoustic space. The other voice signature may be a new voice signature (i.e., one not presently stored in the system) or one previously detected and associated with a different acoustic space. In either instance, detecting another voice signature in an acoustic space previously associated with a different voice signature may cause the system to update the association information accordingly.

For example, referring to FIG. 14B, after having detected one or more instances of voice input from the first user 1406a in the first acoustic space 1402a (such that the first voice signature is associated with the first acoustic space 1402a, as discussed above), the network device 1404a may detect a third voice input 1408c from a third user 1406c, as indicated by arrow 1410c. In the illustrated example, the network device 1404a passes the voice input to the hub device 1404b for processing, as indicated by arrow 1412c. The hub device 1404b processes the voice input to extract a third voice command and to determine a third voice signature (corresponding to the third user 1406c) associated with the third voice input 1408c, as discussed above. Referring again to FIG. 15, in step 1514, the processing may include determining that the third voice signature has been detected in the first acoustic space and that the third voice signature does not match the previously stored first voice signature associated with the first acoustic space 1402a. In such scenarios, detection of the different voice signature in an acoustic space previously associated with another voice signature may indicate a loss of confidence in inferences that are based on the association between the first voice signature and the acoustic space. Accordingly, in certain examples, the voice command contained in the third voice input 1408c may correspond to an “override” voice command, namely one that causes the system to remove the association between the first voice signature and the first acoustic space 1402a, or optionally to delete the first voice signature. Thus, in step 1516, the hub device 1404b may update the association information for the first voice signature to remove the association with the first acoustic space 1402a. In certain examples, step 1516 may include completely deleting the first voice signature, and its association information, from the media playback system. Further, hub device 1404b may store the new, third voice signature along with association information that identifies the corresponding voice command and one or more network devices that executed the voice command, and associates the third voice signature with the first acoustic space (step 1504), as discussed above.

Thus, aspects and embodiments provide for the use of determined acoustic spaces in combination with voice signature matching to allow the media playback system to autonomously disambiguate certain voice commands and thereby enhance user experiences and interactions with the media playback system. As discussed above, both in examples in which acoustic spaces are used and those in which they are not, monitored voice signatures may be temporarily, but not permanently, stored by the media playback system. In certain examples, as discussed above, override voice commands can cause one or more previously stored voice signatures to be deleted from the system. In other examples, voice signatures may be stored for a defined, configurable time period (e.g., in a range of about 15 or 30 minutes to several hours). In certain examples, a timer to monitor the time period may be set for each voice signature when it is detected and stored by the media playback system. If the voice signature is not detected again by one or more network devices (which may reset the timer) before expiration of the timer, the voice signature may be deleted. As discussed above, this approach has both privacy benefits as well as benefits derived from regularly updating system information and preventing potentially incorrect target devices to be identified or other actions to be taken based on old information that may no longer be valid or relevant.

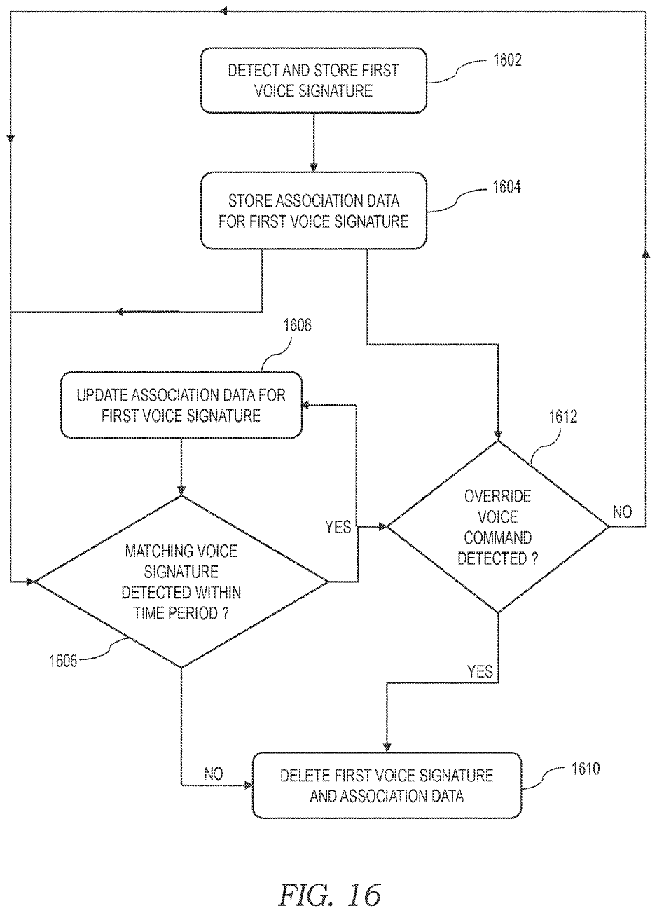

FIG. 16 is a flow diagram illustrating an example of a process for monitoring voice signatures according to certain aspects. At step 1602, a listening device detects a voice input from a user and the system processes the voice input to identify a first unique voice signature associated with the voice input, as discussed above. As also discussed above, this processing may include various other actions, such as extracting a voice command from the voice input, determining an intent of the voice command, determining an acoustic space associated with the voice input, identifying one or more target devices to execute the voice command, and/or instructing the one or more target devices to execute the voice command.

At step 1604, the system stores the first voice signature along with association information, as discussed above.

The system may then monitor for the first voice signature to determine whether or not a voice signature matching the first voice signature is detected within a defined time period (decision block 1606). As discussed above, in certain examples, the system may activate a timer associated with the first voice signature and monitor to determine whether or not a matching voice signature is detected prior to expiration of the timer. If a matching voice signature is detected within the defined time period, the system may update the association information stored with the first voice signature (step 1608), as discussed above. This may reset the time period, in which case the system again waits to determine if another instance of a matching voice signature is detected within the newly reset time period. If no matching voice signature is detected within the defined time period, the system may delete the first voice signature and its association information (step 1610).

In addition to the storage of voice signatures having a time limit, detection of potentially conflicting voice commands associated with other voice signatures (“override commands”) may also cause the system to delete the first voice signature and its association information in step 1610. According to certain examples, during the time period corresponding to decision block 1606, the system may also monitor to determine whether an override voice command is detected (decision block 1612). For example, as discussed above with reference to FIG. 14B, detecting a voice command associated with the third voice signature (corresponding to the third user 1406c) in the first acoustic space 1402a previously associated with the first voice signature may constitute detecting an override command since, in this scenario, it may be more relevant to now associate the more-recently detected third voice signature with the first acoustic space 1402a rather than the original first voice signature. Accordingly, as discussed above, if an override command is detected, the system may proceed to step 1610 and delete the first voice signature and its association information. Otherwise, the system may continue monitoring until expiration of the defined time period or detection of a matching voice signature.

Thus, aspects and embodiments provide network devices, systems, and methods that allow for disambiguating voice commands based on determining the acoustic space surrounding the user who uttered the voice command and/or by tracking temporary voice signatures that interact with the media playback system. The techniques disclosed herein may reduce the need for a user to utter very specific, precise voice commands and allow the user to interact with the media playback system in a more natural and streamlined way, thereby enhancing the user experience.

### V. CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain aspects of the present disclosure can be practiced without certain, specific details. In other instances, well known methods, procedures, components, and circuitry have not been described in detail to avoid unnecessarily obscuring aspects of the examples and aspects of the present technology. Accordingly, the scope of the present disclosure is defined by the appended claims rather than the forgoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. EXAMPLES

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

(Example 1) A method of directing voice commands for playback devices, the method comprising: detecting a voice input via a first playback device, the voice input including a voice command to be executed by at least one playback device in a set of playback devices; determining that the voice input does not identify any playback device in the set of playback devices; after the determination, causing the set of playback devices to broadcast a set of signals, wherein each playback device in the set of playback devices broadcasts a respective signal in the set of signals; detecting, via the first playback device, one or more respective signals in the set of signals; identifying at least one second playback device of the set of playback devices based on the detected one or more respective signals; and causing the at least one second playback device to execute the voice command.

(Example 2) The method of Example 1, further comprising before detecting the voice input via the first playback device, detecting a playback command via the at least one second playback device, wherein the playback command causes the at least one second playback device to play back audio content, and wherein causing the at least one second playback device to execute the voice command comprises causing the at least one second playback device to cease the playback of the audio content.

(Example 3) The method of Example 2, wherein detecting the playback command comprises detecting a voice input via the at least one second playback device, wherein the voice input detected by the at least one second playback device comprises the playback command.

(Example 4) The method of either Example 2 or Example 3, wherein detecting the playback command comprises detecting the playback command via one of: a user interface of the at least one second playback device; or a user interface of a control device associated with the set of playback devices.

(Example 5) The method of any one of Examples 1-4, wherein causing the set of playback devices to broadcast the set of signals comprises causing the set of playback devices to broadcast a set of audio signals.

(Example 6) The method of Example 5, wherein causing the set of playback devices to broadcast the set of audio signals comprises causing the set of playback devices to broadcast a set of ultrasound signals.

(Example 7) The method of any one of Examples 1-6, wherein detecting the one or more respective signals comprises comparing to one another each respective signal of the one or more respective signals.

(Example 8) The method of any one of Examples 1-7, wherein identifying the at least one second playback device comprises identifying the at least one second playback device based on the respective signal issued by the at least one second playback device having a highest signal strength among the one or more respective signals.

(Example 9) The method of any one of Examples 1-6, wherein detecting the one or more respective signals comprises determining that at least one of the one or more respective signals has a signal strength exceeding a predetermined threshold value.

(Example 10) The method of any one of Examples 1-9, wherein identifying the at least one second playback device further comprises determining that the at least one second playback device is playing back audio content prior to the first playback device detecting the voice input, and wherein the voice command comprises a command to alter the playback of the audio content.

(Example 11) The method of Example 10, wherein the command to alter the playback of the audio content comprises at least one of: adjusting a volume of the playback of the audio content; grouping the at least one second playback device with one or more other playback devices; and changing playback of a current media item to another media item.

(Example 12) The method of any one of Examples 1-9, wherein identifying the at least one second playback device further comprises determining that the at least one second playback device has a context that matches the voice command.

(Example 13) The method of Example 12, further comprising: determining an intent of the voice command; wherein determining that the second playback device has a context that matches the voice command includes determining that the context can be altered to fulfill the intent of the voice command.

(Example 14) The method of any one of Examples 1-13, wherein detecting, via the first playback device, the one or more respective signals includes extracting a playback device identifier from each of the one or more respective signals.

(Example 15) The method of any one of Examples 1-14, wherein the voice input includes a wake word.

(Example 16) A method of directing voice commands for playback devices, the method comprising: detecting, via a first playback device, a voice command to be executed by at least one playback device in a set of playback devices, wherein the voice does not identify any playback device in the set of playback devices; determining an acoustic space that includes the first playback device and one or more playback devices in the set of playback devices; identifying, from among the one or more other playback devices in the acoustic space, at least one second playback device based on a context of the at least one second playback device that matches the voice command; and causing the at least one second playback device to execute the voice command.

(Example 17) The method of Example 16, further comprising: determining an intent of the voice command; wherein identifying the at least one second playback device based on the context of the at least one second playback device that matches the voice command comprises determining that the context of the at least one second playback device can be altered to fulfill the intent of the voice command.

(Example 18) The method of Example 17, wherein determining the intent of the voice command includes determining that the intent of the voice command is to alter playback of audio content; and wherein determining that the context of the at least one second playback device can be altered to fulfill the intent of the voice command includes determining that the at least one second playback device is playing back the audio content.

(Example 19) The method of Example any one of Examples 16-18, wherein determining the acoustic space comprises: causing the set of playback devices to broadcast a set of signals, wherein each playback device in the set of playback devices broadcasts a respective signal in the set of signals; detecting the respective signals from the one or more playback devices in the set of playback devices; and determining that the acoustic space comprises the one or more playback devices based on detecting the respective signals from the one or more playback devices.

(Example 20) The method of Example 19, wherein detecting the respective signals from the one or more playback devices in the set of playback devices comprises detecting the respective signals each having a signal strength that exceeds a predetermined threshold value.

(Example 21) The method of either Example 19 or Example 20, wherein causing the set of playback devices to broadcast the set of signals comprises causing the set of playback devices to broadcast a set of audio signals.

(Example 22) The method of Example 21, wherein causing the set of playback devices to broadcast the set of audio signals comprises causing the set of playback devices to broadcast a set of ultrasonic signals.

(Example 23) A method of directing voice commands for playback devices, the method comprising: detecting a voice command to be executed by at least one first playback device in a set of playback devices, wherein the voice command does not identify the at least one first playback device; causing the set of playback devices to broadcast a set of signals, wherein each playback device in the set of playback devices broadcasts a respective signal in the set of signals; detecting one or more respective signals in the set of signals; identifying the at least one first playback device based on detecting the respective signal from the at least one first playback device and determining that an intent of the voice command will be fulfilled by the at least one first playback device executing the voice command; and causing the at least one first playback device to execute the voice command.

(Example 24) The method of Example 23, wherein detecting the voice command includes detecting the voice command at a second playback device in the set of playback devices.

(Example 25) The method of either Example 23 or Example 24, wherein detecting the voice command includes detecting the voice command at one of a network microphone device or a controller device.

(Example 26) The method of any one of Examples 23-25, wherein determining that the intent of the voice command will be fulfilled by the at least one first playback device executing the voice command comprises: determining that the at least one first playback device is playing back audio content; and determining that the intent of the voice command is to alter the playback of the audio content.

(Example 27) A method of directing voice commands for playback devices, the method comprising: detecting a voice input at a first playback device, the voice input including a voice command executable by a plurality of playback devices in a set of playback devices; determining that an acoustic space around the first playback device includes at least one second playback device of the plurality of playback devices; and causing the at least one second playback device to execute the voice command based at least in part on a presence of the at least one second playback device in the acoustic space.

(Example 28) The method of Example 27, wherein determining that the acoustic space includes the at least one second playback device comprises: causing the set of playback devices to broadcast a set of signals, wherein each playback device in the set of playback devices broadcasts a respective signal in the set of signals; detecting the respective signal from the at least one second playback device; and determining that the at least one second playback device is in the acoustic space based on detection of the respective signal from the at least one second playback device.

(Example 29) A network microphone device comprising: at least one microphone configured to detect a voice input; at least one network interface; at least one processor including a voice processor operably coupled to the at least one microphone; and at least one non-transitory computer-readable medium storing program instructions that are executable by the at least one processor such that the network microphone device is configured to: extract a voice command from the voice input using the voice processor, transmit, via the at least one network interface, one or more data signals to a set of playback devices to cause the set of playback devices to broadcast a set of signals, wherein each playback device in the set of playback devices broadcasts a respective signal in the set of signals, detect, via the at least one network interface, one or more respective signals in the set of signals, identify at least one playback device in the set of playback devices based at least in part on detection of the respective signal from the at least one playback device, and cause the at least one playback device to execute the voice command.

(Example 30) A method of directing voice commands in a media playback system, the method comprising: detecting a first voice input including a first voice command to be executed by a first playback device in the media playback system; deriving a first voice signature from the first voice input; temporarily storing a first data set comprising the first voice signature and association information that associates the first voice signature with the first voice command and the first playback device; detecting a second voice input including a second voice command executable by a plurality of playback devices in the media playback system, the plurality of playback devices including the first playback device; deriving a second voice signature from the second voice input; comparing the first voice signature to the second voice signature; identifying a signature match based on the comparison; and based on the signature match and the association information stored in the first data set, causing the first playback device to execute the second voice command.

(Example 31) The method of Example 30, wherein the second voice command does not identify any playback device in the media playback system.

(Example 32) The method of one of Examples 30 or 31, further comprising: after a predetermined time period has elapsed without any playback device in the plurality of playback devices having detected a third voice input associated with the first voice signature, removing from storage the first data set.

(Example 33) The method of Example 32, further comprising removing from storage the first voice signature.

(Example 34) The method of Example 30, further comprising: after detecting the second voice input, detecting a third voice input to be executed by the first playback device, wherein the third voice input has a third voice signature different from the first voice signature; and after detecting the third voice input, removing from storage the first voice signature.

(Example 35) The method of Example 30, further comprising after detecting the first voice input to be executed by a first playback device: removing from storage the first data set; or updating the first data set to disassociate the first voice signature and the association information.

(Example 36) The method of any one of Examples 30-35, wherein the first playback device and at least one other playback device in the plurality of playback devices each have a context associated with the second voice command.

(Example 37) The method of Example 36, wherein the context comprises playing back audio content, and wherein the second voice command comprises a command to alter the playback of the audio content.

(Example 38) The method of Example 36, wherein the second voice command comprises one of a command to stop the playback of the audio content, a command to change a volume of the playback of the audio content, a command to change an audio source of the audio content, or a command to identify the audio content.

(Example 39) A method of directing voice commands for playback devices, the method comprising: detecting a first voice command executable by a plurality of playback devices; determining that the voice command matches a stored voice signature; based on the stored voice signature, accessing association information contained in a stored data set that also contains the stored voice signature, the association information associating the stored voice signature with a second voice command and identifying a first playback device in the plurality of playback devices that executed the second voice command; identifying the first playback device based at least in part on the association information; and causing the first playback device to execute the first voice command.

(Example 40) The method of Example 39, wherein identifying the first playback device further comprises: determining an intent of the first voice command; and determining that the first playback device has a context that can be altered by execution of the first voice command.

(Example 41) The method of Example 40, wherein the association information contained in the stored data set specifies an intent of the second voice command.

(Example 42) The method of any of Examples 39-41, wherein execution of the second voice command by the first playback device causes the first playback device to play back of audio content; and wherein execution of the first voice command by the first playback device causes the first playback device to alter the playback of the audio content.

(Example 43) The method of Example 42, wherein the audio content includes at least one audio channel of a multi-channel audio stream.

(Example 44) The method of one of Examples 42 or 43, wherein the first voice command comprises one of a command to stop the playback of the audio content, a command to change a volume of the playback of the audio content, a command to change an audio source of the audio content, or a command to identify the audio content.

(Example 45) The method of any one of Examples 39-44, further comprising: updating the association information contained in the stored data set to associate the first voice command with the stored voice signature and the first playback device.

(Example 46) The method of any one of Examples 39-45, further comprising: after a predetermined time period following detection of the first voice command, deleting the stored voice signature and the association information based on there being no detection of a voice signature matching the stored voice signature during the predetermined time period.

(Example 47) The method of any one of Examples 39-46, wherein the first voice command does not specify the first playback device.

(Example 48) A method of directing voice commands to playback devices, the method comprising: detecting, at a network microphone device, a voice input articulating a first voice command recognizable by at least one playback device of a plurality of playback devices; identifying a first intent of the first voice command; determining that a first playback device of the plurality of playback devices and a second playback device of the plurality of playback devices each have a context that can be altered to fulfill an intent of the first voice command; deriving a voice signature from the voice input; determining that the voice signature matches a stored voice signature; accessing a stored data set containing the stored voice signature and association information that associates the stored voice signature with a second voice command having a second intent related to the first intent and identifies that the first playback device executed the second voice command; identifying the first playback device as a target device for the first voice command based on the association information; and causing the first playback device to execute the first voice command.

(Example 49) The method of Example 48, wherein the second intent comprises an intent to cause the first playback device to begin playback of audio content, and wherein the first intent comprises an intent to cause the first playback device to stop playback of the audio content.

(Example 50) A method of directing voice commands in a media playback system, the method comprising: detecting at a first playback device, a first voice input specifying a first voice command directed to the first playback device; deriving a first voice signature from the first voice input; causing the first playback device to execute the first voice command; storing a data set comprising the first voice signature and association information that associates the first voice signature with the first voice command and the first playback device; detecting at a second playback device, a second voice input including a second voice command executable by a plurality of playback devices including the first playback device and at least one other playback device, wherein the second voice command does not identify any playback device in the plurality of playback devices; based on a determination that the second voice command is associated with the first voice signature, accessing the first data set; and based on the association information contained in the first data set, causing the first playback device to execute the second voice command.

(Example 51) A network microphone device comprising: at least one microphone configured to detect a voice input; at least one network interface; at least one processor including a voice processor operably coupled to the at least one microphone; and at least one non-transitory computer-readable medium storing program instructions that are executable by the at least one processor such that the network microphone device is configured to: detect, with the at least one microphone, a first voice input including a first voice command to be executed by a first playback device in the media playback system; derive a first voice signature from the first voice input using the voice processor; store a first data set comprising the first voice signature and association information that associates the first voice signature with the first voice command and the first playback device; detect, with the at least one microphone, a second voice input including a second voice command executable by a plurality of playback devices in the media playback system, the plurality of playback devices including the first playback device; derive a second voice signature from the second voice input; compare the first voice signature to the second voice signature; identify a signature match based on the comparison; and based on the signature match and the association information stored in the first data set, cause the first playback device to execute the second voice command.

(Example 52) A method of directing voice commands for playback devices, the method comprising: detecting, via a first playback device, a voice command to be executed by at least one playback device in a set of playback devices, wherein the voice does not identify any playback device in the set of playback devices; determining that one or more additional playback devices of the set of playback devices are in an acoustic space that includes the first playback device; identifying, from among the one or more other playback devices in the acoustic space, at least one second playback device from the one or more playback devices in the acoustic space to execute the command; and causing the at least one second playback device to execute the voice command.

(Example 53) The method of Example 52, further comprising determining that one or more additional playback devices of the set of playback devices are in an acoustic space that includes the first playback device, wherein determining the acoustic space comprises: causing the set of playback devices to broadcast a set of signals, wherein each playback device in the set of playback devices broadcasts a respective signal in the set of signals; detecting the respective signals from the one or more playback devices in the set of playback devices; and determining that the acoustic space comprises the one or more additional playback devices based on detecting the respective signals from the one or more playback devices.

(Example 54) The method of one of Examples 52 or 53, wherein the voice command is included in voice input detected via the first playback device, the method further comprising, before detecting the voice input via the first playback device, detecting a playback command via the at least one second playback device, wherein the playback command causes the at least one second playback device to play back audio content, and wherein causing the at least one second playback device to execute the voice command comprises causing the at least one second playback device to cease the playback of the audio content.

(Example 55) The method of Example 54, wherein detecting the playback command comprises detecting a voice input via the at least one second playback device, wherein the voice input detected by the at least one second playback device comprises the playback command.

(Example 56) The method of Example 54, wherein detecting the playback command comprises detecting the playback command via one of: a user interface of the at least one second playback device, or a user interface of a control device associated with the set of playback devices.

(Example 57) The method of any one of Examples 52-56, wherein the set of signals broadcast by the set of playback devices are at least one of audio signals or and ultrasound signals.

(Example 58) The method of any one of Examples 52-57, wherein identifying the at least one second playback device comprises comparing the respective signals.

(Example 59) The method of any one of Examples 52-58, wherein identifying the at least one second playback device is based at least in part on at least one of the respective signal issued by the at least one second playback device having a highest signal strength among the one or more respective signals, and at least one of the one or more respective signals having a signal strength exceeding a predetermined threshold value.

(Example 60) The method of any one of Examples 52-59, wherein identifying the at least one second playback device further comprises determining that the at least one second playback device is playing back audio content prior to the first playback device detecting the voice command, and wherein the voice command comprises a command to alter the playback of the audio content.

(Example 61) The method of any one of Examples 52-60, wherein identifying the at least one second playback device further comprises determining that the at least one second playback device has a context that matches the voice command.

(Example 62) The method of Example 61, further comprising determining an intent of the voice command, wherein determining that the second playback device has a context that matches the voice command includes determining that the context can be altered to fulfill the intent of the voice command.

(Example 63) The method of Example 62, wherein determining the intent of the voice command includes determining that the intent of the voice command is to alter playback of audio content, and wherein determining that the context of the at least one second playback device can be altered to fulfill the intent of the voice command includes determining that the at least one second playback device is playing back the audio content.

(Example 64) The method of Example 63, wherein the command to alter the playback of the audio content comprises at least one of adjusting a volume of the playback of the audio content, grouping the at least one second playback device with one or more other playback devices, and changing playback of a current media item to another media item.

(Example 65) The method of any one of Examples 52-64, wherein detecting, via the first playback device, the one or more respective signals includes extracting a playback device identifier from each of the one or more respective signals.

(Example 66) The method of any one of Examples 52-65, wherein the voice command is included in voice input detected via the first playback device, and wherein the voice input further includes a wake word.

(Example 67) The method of any one of Examples 52-66, further comprising determining that the voice command does not identify any playback device of the set of playback devices.

(Example 68) A method of directing voice commands for playback devices, the method comprising: detecting a voice command to be executed by at least one first playback device in a set of playback devices, wherein the voice command does not identify a playback device to execute the command; causing the set of playback devices to broadcast a set of signals, wherein each playback device in the set of playback devices broadcasts a respective signal in the set of signals; detecting one or more respective signals in the set of signals; identifying at least one first playback device to execute the voice command based on: detecting the respective signal from the at least one first playback device, and determining that an intent of the voice command will be fulfilled by the at least one first playback device executing the voice command; and causing the at least one first playback device to execute the voice command.

(Example 69) The method of Example 68, wherein detecting the voice command includes detecting the voice command at a second playback device in the set of playback devices.

(Example 70) The method of Example 68, wherein detecting the voice command includes detecting the voice command at one of a network microphone device or a controller device.

(Example 71) The method of any one of Examples 68-70, wherein determining that the intent of the voice command will be fulfilled by the at least one first playback device executing the voice command comprises determining that the at least one first playback device is playing back audio content, and determining that the intent of the voice command is to alter playback of audio content.

(Example 72) A network microphone device comprising: at least one microphone configured to detect a voice input; at least one network interface; at least one processor including a voice processor operably coupled to the at least one microphone; and at least one non-transitory computer-readable medium storing program instructions that are executable by the at least one processor such that the network microphone device is configured to: extract a voice command from the voice input using the voice processor, transmit, via the at least one network interface, one or more data signals to a set of playback devices to cause the set of playback devices to broadcast a set of signals, wherein each playback device in the set of playback devices broadcasts a respective signal in the set of signals, detect, via the at least one network interface, one or more respective signals in the set of signals, identify at least one playback device in the set of playback devices based at least in part on detection of the respective signal from the at least one playback device, and cause the at least one playback device to execute the voice command.

(Example 73) A method of directing voice commands in a media playback system, the method comprising: detecting a first voice input including a first voice command to be executed by a first playback device in the media playback system; deriving a first voice signature from the first voice input; temporarily storing a first data set comprising the first voice signature and association information that associates the first voice signature with the first voice command and the first playback device; detecting a second voice input including a second voice command executable by a plurality of playback devices in the media playback system, the plurality of playback devices including the first playback device; deriving a second voice signature from the second voice input; comparing the first voice signature to the second voice signature; identifying a signature match based on the comparison; and based on the signature match and the association information stored in the first data set, causing the first playback device to execute the second voice command.

(Example 74) The method of Example 73, wherein the second voice command does not identify any playback device in the media playback system.

(Example 75) The method of one of Examples 73 or 74, further comprising, after a predetermined time period has elapsed without any playback device in the plurality of playback devices having detected a third voice input associated with the first voice signature, removing from storage the first data set.

(Example 76) The method of Example 75, further comprising removing from storage the first voice signature.

(Example 77) The method of one of Examples 73 or 74, further comprising, after detecting the second voice input, detecting a third voice input to be executed by the first playback device, wherein the third voice input has a third voice signature different from the first voice signature, and after detecting the third voice input, removing from storage the first voice signature.

(Example 78) The method of Example 73, further comprising after detecting the first voice input to be executed by a first playback device: removing from storage the first data set, or updating the first data set to disassociate the first voice signature and the association information.

(Example 79) The method of any one of Examples 73-78, wherein the first playback device and at least one other playback device in the plurality of playback devices each have a context associated with the second voice command, wherein the context comprises playing back audio content, and wherein the second voice command comprises a command to alter the playback of the audio content.

(Example 80) The method of Example 79, wherein the second voice command comprises one of a command to stop the playback of the audio content, a command to change a volume of the playback of the audio content, a command to change an audio source of the audio content, or a command to identify the audio content.

(Example 81) A method of directing voice commands for playback devices, the method comprising: detecting a first voice command executable by a plurality of playback devices; determining that the voice command matches a stored voice signature; based on the stored voice signature, accessing association information contained in a stored data set that also contains the stored voice signature, the association information associating the stored voice signature with a second voice command and identifying a first playback device in the plurality of playback devices that executed the second voice command; identifying the first playback device based at least in part on the association information; and causing the first playback device to execute the first voice command.

(Example 82) The method of Example 81, wherein identifying the first playback device further comprises determining an intent of the first voice command, and determining that the first playback device has a context that can be altered by execution of the first voice command.

(Example 83) The method of Example 82, wherein the association information contained in the stored data set specifies an intent of the second voice command.

(Example 84) The method of any one of Examples 81-83, wherein execution of the second voice command by the first playback device causes the first playback device to play back of audio content, and wherein execution of the first voice command by the first playback device causes the first playback device to alter the playback of the audio content.

(Example 85) The method of Example 84, wherein the audio content includes at least one audio channel of a multi-channel audio stream.

(Example 86) The method of one of Examples 84 or 85, wherein the first voice command comprises one of a command to stop the playback of the audio content, a command to change a volume of the playback of the audio content, a command to change an audio source of the audio content, or a command to identify the audio content.

(Example 87) The method of any one of Examples 81-86, further comprising updating the association information contained in the stored data set to associate the first voice command with the stored voice signature and the first playback device.

(Example 88) The method of any one of Examples 81-87, further comprising, after a predetermined time period following detection of the first voice command, deleting the stored voice signature and the association information based on there being no detection of a voice signature matching the stored voice signature during the predetermined time period.

(Example 89) The method of any one of Examples 81-88, wherein the first voice command does not specify the first playback device.

(Example 90) A method of directing voice commands to playback devices, the method comprising: detecting, at a network microphone device, a voice input articulating a first voice command recognizable by at least one playback device of a plurality of playback devices; identifying a first intent of the first voice command; determining that a first playback device of the plurality of playback devices and a second playback device of the plurality of playback devices each have a context that can be altered to fulfill an intent of the first voice command; deriving a voice signature from the voice input; determining that the voice signature matches a stored voice signature; accessing a stored data set containing the stored voice signature and association information that associates the stored voice signature with a second voice command having a second intent related to the first intent and identifies that the first playback device executed the second voice command; identifying the first playback device as a target device for the first voice command based on the association information; and causing the first playback device to execute the first voice command.

(Example 91) The method of Example 90, wherein the second intent comprises an intent to cause the first playback device to begin playback of audio content, and wherein the first intent comprises an intent to cause the first playback device to stop playback of the audio content.

(Example 92) A method of directing voice commands in a media playback system, the method comprising: detecting at a first playback device, a first voice input specifying a first voice command directed to the first playback device; deriving a first voice signature from the first voice input; causing the first playback device to execute the first voice command; storing a data set comprising the first voice signature and association information that associates the first voice signature with the first voice command and the first playback device; detecting at a second playback device, a second voice input including a second voice command executable by a plurality of playback devices including the first playback device and at least one other playback device, wherein the second voice command does not identify any playback device in the plurality of playback devices; based on a determination that the second voice command is associated with the first voice signature, accessing the first data set; and based on the association information contained in the first data set, causing the first playback device to execute the second voice command.

(Example 93) A network microphone device comprising: at least one microphone configured to detect a voice input; at least one network interface; at least one processor including a voice processor operably coupled to the at least one microphone; and at least one non-transitory computer-readable medium storing program instructions that are executable by the at least one processor such that the network microphone device is configured to: detect, with the at least one microphone, a first voice input including a first voice command to be executed by a first playback device in the media playback system, derive a first voice signature from the first voice input using the voice processor, store a first data set comprising the first voice signature and association information that associates the first voice signature with the first voice command and the first playback device, detect, with the at least one microphone, a second voice input including a second voice command executable by a plurality of playback devices in the media playback system, the plurality of playback devices including the first playback device, derive a second voice signature from the second voice input, compare the first voice signature to the second voice signature, identify a signature match based on the comparison, and based on the signature match and the association information stored in the first data set, cause the first playback device to execute the second voice command.

1. A method of directing voice commands for playback devices, the method comprising:
detecting, via a first playback device, a voice command to be executed by at least one playback device in a set of playback devices, wherein the voice command does not identify any playback device in the set of playback devices;
determining an intent of the voice command;
determining that one or more additional playback devices of the set of playback devices are in an acoustic space that includes the first playback device;
identifying, from among the one or more other playback devices in the acoustic space, at least one second playback device from the one or more playback devices in the acoustic space to execute the command, wherein identifying the at least one second playback device comprises determining that the at least one second playback device has a context that can be altered to fulfill the intent of the voice command; and
causing the at least one second playback device to execute the voice command.

2. The method of claim 1, wherein determining that the one or more additional playback devices of the set of playback devices are in the acoustic space that includes the first playback device comprises:
causing the set of playback devices to broadcast a set of signals, wherein each playback device in the set of playback devices broadcasts a respective signal in the set of signals;
detecting the respective signals from the one or more playback devices in the set of playback devices; and
determining that the acoustic space comprises the one or more additional playback devices based on detecting the respective signals from the one or more playback devices.

3. The method of claim 1, wherein the voice command is included in voice input detected via the first playback device, the method further comprising, before detecting the voice input via the first playback device, detecting a playback command via the at least one second playback device, wherein the playback command causes the at least one second playback device to play back audio content, and wherein causing the at least one second playback device to execute the voice command comprises causing the at least one second playback device to cease the playback of the audio content.

4. The method of claim 3, wherein detecting the playback command comprises detecting a voice input via the at least one second playback device, wherein the voice input detected by the at least one second playback device comprises the playback command.

5. (canceled)

6. The method of claim 2, wherein the set of signals broadcast by the set of playback devices are at least one of:
audio signals; and
ultrasound signals.

7. (canceled)

8. (canceled)

9. (canceled)

10. (canceled)

11. (canceled)

12. The method of claim 1, wherein determining the intent of the voice command includes determining that the intent of the voice command is to alter playback of audio content; and
wherein determining that the context of the at least one second playback device can be altered to fulfill the intent of the voice command includes determining that the at least one second playback device is playing back the audio content.

13. The method of claim 12, wherein the command to alter the playback of the audio content comprises at least one of:
adjusting a volume of the playback of the audio content;
grouping the at least one second playback device with one or more other playback devices; and
changing playback of a current media item to another media item.

14. The method claim 2, wherein detecting, via the first playback device, the respective signals includes extracting a playback device identifier from each of the respective signals.

15. The method of claim 1, wherein the voice command is included in voice input detected via the first playback device, and wherein the voice input further includes a wake word.

16. (canceled)

17. A method of directing voice commands for playback devices, the method comprising:
detecting a voice command to be executed by at least one first playback device in a set of playback devices, wherein the voice command does not identify a playback device to execute the command;
causing the set of playback devices to broadcast a set of signals, wherein each playback device in the set of playback devices broadcasts a respective signal in the set of signals;
detecting one or more respective signals in the set of signals;
identifying the at least one first playback device to execute the voice command based on: (i) detecting the respective signal from the at least one first playback device; and (ii) determining that an intent of the voice command will be fulfilled by the at least one first playback device executing the voice command; and
causing the at least one first playback device to execute the voice command.

18. The method of claim 17, wherein detecting the voice command includes detecting the voice command at a second playback device in the set of playback devices.

19. The method of claim 17, wherein detecting the voice command includes detecting the voice command at one of a network microphone device or a controller device.

20. The method of claim 17, wherein determining that the intent of the voice command will be fulfilled by the at least one first playback device executing the voice command comprises:
determining that the at least one first playback device is playing back audio content; and
determining that the intent of the voice command is to alter playback of audio content.

21. (canceled)

22. A method of directing voice commands in a media playback system, the method comprising:
detecting a first voice input including a first voice command to be executed by a first playback device in the media playback system;
deriving a first voice signature from the first voice input;
temporarily storing a first data set comprising the first voice signature and association information that associates the first voice signature with the first voice command and the first playback device;
detecting a second voice input including a second voice command executable by a plurality of playback devices in the media playback system, the plurality of playback devices including the first playback device, wherein the second voice command does not identify any playback device in the media playback system;
deriving a second voice signature from the second voice input;
comparing the first voice signature to the second voice signature;
identifying a signature match based on the comparison; and
based on the signature match and the association information stored in the first data set, causing the first playback device to execute the second voice command.

23. (canceled)

24. The method claim 22, further comprising:
after a predetermined time period has elapsed without any playback device in the plurality of playback devices having detected a third voice input associated with the first voice signature, removing from storage the first data set.

25. The method of claim 24, further comprising removing from storage the first voice signature.

26. The method of claim 22, further comprising:
after detecting the second voice input, detecting a third voice input to be executed by the first playback device, wherein the third voice input has a third voice signature different from the first voice signature; and
after detecting the third voice input, removing from storage the first voice signature.

27. The method of claim 22, further comprising after detecting the first voice input to be executed by a first playback device:
removing from storage the first data set; or
updating the first data set to disassociate the first voice signature and the association information.

28. The method of claim 22, wherein the first playback device and at least one other playback device in the plurality of playback devices each have a context associated with the second voice command, wherein the context comprises playing back audio content, and wherein the second voice command comprises a command to alter the playback of the audio content.

29. The method of claim 28, wherein the second voice command comprises one of a command to stop the playback of the audio content, a command to change a volume of the playback of the audio content, a command to change an audio source of the audio content, or a command to identify the audio content.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
